(19) United States
(12) Patent Application Publication
(10) Pub. No.: US 2021/0402508 A1
(43) Pub. Date: Dec. 30, 2021

(54) FRICTION STIR WELDING APPARATUS AND FRICTION STIR WELDING METHOD

(71) Applicant: HONDA MOTOR CO., LTD., Tokyo (JP)

(72) Inventors: Akiyoshi Miyawaki, Wako-shi (JP); Mitsuru Sayama, Wako-shi (JP); Taichi Kurihara, Wako-shi (JP)

(21) Appl. No.: 17/353,855

(22) Filed: Jun. 22, 2021

(30) Foreign Application Priority Data
Jun. 26, 2020 (JP) 2020-110464

(51) Int. Cl. B23K 20/12

(52) U.S. Cl. CPC B23K 20/1255; B23K 2103/10

(57) ABSTRACT

A friction stir welding apparatus includes a probe, a shoulder, a plurality of air chambers, and a communication part. The probe is pressed to a joint part of a plurality of joined members while being rotated. The shoulder is formed to surround the probe. The plurality of air chambers are formed between an outer surface of the probe and an inner surface of the shoulder. The communication part causes the plurality of air chambers to communicate with each other and is formed such that a distance between the probe and the shoulder is smaller than those of the plurality of air chambers.

### CROSS-REFERENCE TO RELATED APPLICATION

Priority is claimed on Japanese Patent Application No. 2020-110464, filed on Jun. 26, 2020, the contents of which are incorporated herein by reference.

### BACKGROUND

### Field of the Invention

The present invention relates to a friction stir welding apparatus and a friction stir welding method.

### Background

As a friction stir welding apparatus, for example, a configuration is known in which by rotating and moving a weld pin (hereinafter, referred to as a probe) on a joined member, the joined member is welded by friction heat that is generated between the probe and the joined member. In this configuration, for example, a gap is formed between the probe and a weld/smoothing shoe (hereinafter, referred to as a shoulder), and an inflow groove that communicates with the gap is formed on the shoulder. According to this configuration, a cutting chip (for example, a burr or the like) that is generated when the joined member is welded by friction stir welding using friction heat enters the gap, and the cutting chip that has entered the gap is guided to the outside via the inflow groove by a lifting operation of an upper region (for example, refer to Published Japanese Translation No. 2019-516555 of the PCT International Publication).

### SUMMARY

However, in the friction stir welding apparatus of Published Japanese Translation No. 2019-516555 of the PCT International Publication, it is conceivable that, since the cutting chip which is generated when the friction stir welding is performed enters the gap between the probe and the shoulder and is guided to the outside from the inflow groove, the quality of a joint part is affected.

An aspect of the present invention is intended to provide a friction stir welding apparatus and a friction stir welding method capable of preventing a cutting chip that is generated at the time of welding of a joined member from entering a gap between a probe and a shoulder.

A friction stir welding apparatus according to a first aspect of the present invention includes: a probe that is pressed to a joint part of a plurality of laminated joined members while being rotated; a shoulder that surrounds the probe at an outside in a radial direction with respect to a rotation axis of the probe; a plurality of air chambers that are formed between an outer surface of the probe and an inner surface of the shoulder; and a communication part that causes the plurality of air chambers to communicate with each other and is formed such that a distance between the probe and the shoulder is smaller than those of the plurality of air chambers.

According to this configuration, the plurality of air chambers are formed between the outer surface of the probe and the inner surface of the shoulder, and the communication part causes the plurality of air chambers to communicate with each other. Accordingly, the cutting chip that is generated at the time of the friction stir welding of the joined member enters an air chamber on the side of the joint part among the plurality of air chambers. The cutting chip that has entered the air chamber enters the next air chamber via the communication part.

Here, the communication part is formed such that the distance between the probe and the shoulder is smaller than that of the air chamber. The cutting chip that enters the communication part enters the air chamber from the communication part, and thereby, the pressure of the cutting chip is lowered due to a pressure loss. By repeating this condition by the plurality of air chambers and the communication part, the flow of the cutting chip can be sufficiently prevented. Thereby, it is possible to prevent a cutting chip that is generated at the time of friction stir welding of the joined member from entering the gap between the probe and the shoulder. Accordingly, it is possible to improve the quality of the joint part at which the plurality of joined members are welded by the friction stir welding using the probe.

A second aspect of the present invention is the friction stir welding apparatus according to the first aspect described above, wherein the outer surface of the probe and the inner surface of the shoulder may be intermittently radially enlarged in an axis direction of the rotation axis from a side of the joined member toward an opposite side, and the plurality of air chambers may be formed of a radially enlarged portion of the probe and a radially enlarged portion of the shoulder.

According to this configuration, each of the outer surface of the probe and the inner surface of the shoulder is intermittently radially enlarged in the axis direction of the rotation axis from the side of the joined member toward the opposite side. A radially enlarged portion (hereinafter, referred to as a protrusion enlarged diameter portion) in a protrusion shape of the probe has a protrusion outer circumferential surface and a protrusion end surface. A radially enlarged portion (hereinafter, referred to as a recess enlarged diameter portion) of the shoulder has a recess inner circumferential surface and a recess end surface. For example, the air chamber is formed of the protrusion outer circumferential surface, the protrusion end surface, a recess inner circumferential surface, and a recess end surface. Accordingly, the plurality of air chambers are formed by the outer surface of the probe and the inner surface of the shoulder being intermittently radially enlarged. For example, the communication part is formed of the protrusion outer circumferential surface and the recess inner circumferential surface. Thereby, a so-called labyrinth structure is formed of a plurality of air chambers and a plurality of communication parts.

Accordingly, the cutting chip that is generated at the time of welding of the joined member enters and is accumulated in the air chamber on the side of the joint part among the plurality of air chambers. The accumulated cutting chip enters the next air chamber via the communication part.

Here, the communication part is formed such that the distance between the probe and the shoulder is narrower than that of the air chamber. Accordingly, the cutting chip enters the air chamber from the communication part, and thereby, the pressure of the cutting chip is lowered due to a pressure loss. Further, the protrusion end surface forms a surface that faces the joint part in the air chamber. Accordingly, the cutting chip that is generated at the time of welding of the joined member enters the air chamber and hits the protrusion end surface, and the flow of the cutting chip can be prevented by a resistance by the protrusion end surface.

By repeating this condition by the plurality of air chambers and the communication part, the flow of the cutting chip can be sufficiently prevented by a plurality of connection parts and a plurality of protrusion end surfaces. Thereby, it is possible to prevent a cutting chip that is generated at the time of welding of the joined member from entering the gap between the probe and the shoulder. Accordingly, it is possible to improve the quality of the joint part at which the plurality of joined members are welded using the probe.

Further, by adjusting the relative position of the probe and the shoulder with respect to the axis direction, the distance between the protrusion end surface and the recess end surface can be adjusted in the axis direction. Thereby, it is possible to adjust the volume of the plurality of air chambers, and, for example, the technique can be applied to the welding of a variety of joined members.

A third aspect of the present invention is the friction stir welding apparatus according to the first or second aspect described above, wherein a distance between an end part of the probe and an end part of the shoulder may be smaller than a distance between an outer surface of the probe and an inner surface of the shoulder in an air chamber that is located at a closest position to the joint part among the plurality of air chambers.

According to this configuration, the distance between the end part of the probe and the end part of the shoulder is made to be smaller than the distance between the outer surface of the probe and the inner surface of the shoulder in the air chamber that is located at the closest position to the joint part among the plurality of air chambers. Accordingly, the cutting chip that is generated at the time of welding of the joined member can be prevented from entering the air chamber that is located at the closest position to the joint part by the gap between the end part of the probe and the end part of the shoulder. Thereby, it is possible to further favorably prevent a cutting chip that is generated at the time of welding of the joined member from entering the gap between the probe and the shoulder.

A friction stir welding method according to a fourth aspect of the present invention is a friction stir welding method using the friction stir welding apparatus according to any one of the first to third aspects described above, wherein the probe and the shoulder are controlled such that rotation numbers of the probe and the shoulder are different from each other.

Here, it is conceivable that heat is generated due to friction between the probe and the shoulder by the rotation numbers of the probe and the shoulder being different from each other. Accordingly, it is conceivable that, in a case where the cutting chip that is generated at the time of welding of the joined member enters the gap between the probe and the shoulder, the fluidity of the cutting chip is enhanced. Therefore, it is conceivable that the cutting chip easily penetrates the gap between the probe and the shoulder, which may affect the quality of the joint part.

Accordingly, by controlling the friction stir apparatus according to any one of the first to third aspects described above, the joint part of the plurality of laminated joined members is welded by the probe. Thereby, it is possible to prevent the cutting chip having an enhanced fluidity by frictional heat from entering the gap between the probe and the shoulder. Thereby, for example, when the plurality of joined members are welded at the joint part using the friction stir apparatus, even in a case where, by controlling the probe and the shoulder such that the rotation numbers of the probe and the shoulder are different from each other, the joint part of the plurality of joined members is welded by the probe, it is possible to improve the quality of the joint part.

According to an aspect of the present invention, it is possible to prevent the cutting chip that is generated at the time of welding of the joined member from entering the gap between the probe and the shoulder.

### BRIEF DESCRIPTION OF THE DRAWINGS

FIG. 1 is a cross-sectional view showing a friction stir welding apparatus of a first embodiment according to the present invention.

FIG. 2 is an enlarged cross-sectional view of a portion II of FIG. 1.

FIG. 3 is a cross-sectional view showing a friction stir welding apparatus of a second embodiment according to the present invention.

FIG. 4 is an enlarged cross-sectional view of a portion IV of FIG. 3.

FIG. 5 is a cross-sectional view showing a friction stir welding apparatus of a third embodiment according to the present invention.

FIG. 6 is an enlarged cross-sectional view of a portion VI of FIG. 5.

FIG. 7 is a cross-sectional view showing a friction stir welding apparatus of a fourth embodiment according to the present invention.

FIG. 8 is an enlarged cross-sectional view of a portion VIII of FIG. 7.

FIG. 9 is a cross-sectional view showing a friction stir welding apparatus of a fifth embodiment according to the present invention.

FIG. 10 is an enlarged cross-sectional view of a portion X of FIG. 9.

FIG. 11 is a cross-sectional view showing a friction stir welding apparatus of a sixth embodiment according to the present invention.

FIG. 12 is an enlarged cross-sectional view of a portion XII of FIG. 11.

FIG. 13 is a cross-sectional view showing a friction stir welding apparatus of a seventh embodiment according to the present invention.

FIG. 14 is an enlarged cross-sectional view of a portion XIV of FIG. 13.

FIG. 15 is a cross-sectional view showing a friction stir welding apparatus of an eighth embodiment according to the present invention.

FIG. 16 is an enlarged cross-sectional view of a portion XVI of FIG. 15.

FIG. 17 is a cross-sectional view showing a friction stir welding apparatus of a ninth embodiment according to the present invention.

FIG. 18 is an enlarged cross-sectional view of a portion XIIIV of FIG. 17.

### DESCRIPTION OF EMBODIMENTS

Hereinafter, a friction stir welding apparatus (FSW: Friction Stir Welding) and a friction stir welding method of embodiments of the present invention will be described with reference to the drawings.

### First Embodiment

As shown in FIG. 1, a friction stir welding apparatus 10 includes a support tool 12, a friction stir welding tool 13, a shoulder 14, first and second air chamber parts (a plurality of air chambers) 15 and 16, a communication part 17, first and second pathway parts 18 and 19, and a drive mechanism (not shown).

A first workpiece (joined member) 21 and a second workpiece (joined member) 22 are arranged (mounted) on the support tool 12 in a laminated state. A recess part (not shown) having a hollow cylindrical shape may be provided on a center part (that is, a portion that corresponds to a probe 26 described later) 12a of the support tool 12 of a surface on which the first workpiece 21 is arranged.

For example, a so-called 5000-system aluminum alloy having a JIS symbol number of 5000 to 5999 is used as the first workpiece 21 and the second workpiece 22.

The first workpiece 21 and the second workpiece 22 are welded at a joint part 23 by the friction stir welding tool 13 in a laminated state on the support tool 12.

The first embodiment is described using an example in which two sheets of the first workpiece 21 and the second workpiece 22 are laminated, and the joint part 23 is welded by the friction stir welding; however, for example, three or more workpieces may be laminated, and the joint part may be welded by the friction stir welding. The first embodiment is described using an example in which two sheets of the first workpiece 21 and the second workpiece 22 are laminated, and the friction stir welding is performed; however, the friction stir welding may be performed in a state where the first workpiece 21 and the second workpiece 22 are butted to each other.

Further, the first embodiment is described using an example in which the friction stir welding apparatus 10 is provided as a fixed type; however, the embodiment is not limited thereto. For example, the friction stir welding apparatus 10 may be provided on an arm of a multi-axis robot disposed in a production line or the like.

The friction stir welding tool 13 includes a probe shaft part 25 and the probe 26. The probe shaft part 25 is formed in a cylindrical shape and is connected to a drive mechanism (not shown). The probe 26 is provided on a front end on the side of the joint part 23 in the probe shaft part 25 coaxially with respect to a rotation axis 28 of the probe shaft part 25.

The probe 26 is formed in a cylindrical shape having a diameter which is smaller than that of the probe shaft part 25. The probe 26 is formed of, for example, steel, stainless steel, aluminum alloy, copper alloy, nickel alloy, tungsten alloy, cobalt alloy, titanium alloy, super hard alloy, ceramics, heat-resistant resin, or the like.

Hereinafter, an axis direction relative to the rotation axis 28 may simply be abbreviated as an “axis direction”. A radial direction relative to the rotation axis 28 of the probe 26 may simply be abbreviated as a “radial direction”, and a circumferential direction relative to the rotation axis 28 of the probe 26 may simply be abbreviated as a “circumferential direction”.

In the probe 26, an outer circumferential surface (outer circumference) 26a is surrounded in a circumferential direction by the shoulder 14 at the outside in the radial direction. The shoulder 14 is formed of, for example, steel, stainless steel, aluminum alloy, copper alloy, nickel alloy, tungsten alloy, cobalt alloy, titanium alloy, super hard alloy, ceramics, heat-resistant resin, or the like. The probe 26 and the shoulder 14 may not be the same material.

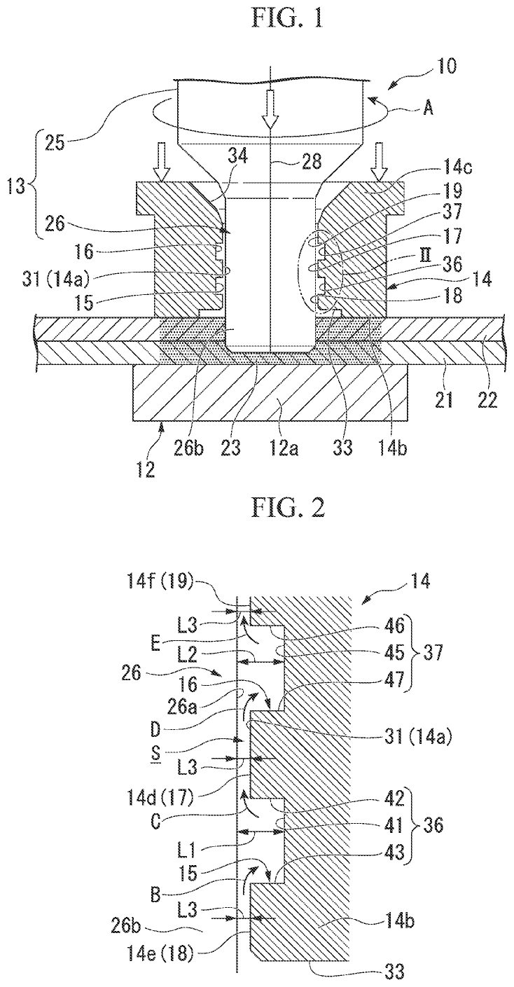

As shown in FIG. 1 and FIG. 2, the shoulder 14 is, for example, a member having a cylindrical shape in which a penetration hole 31 that penetrates in the axis direction is formed. The shoulder 14 has an inner circumferential surface (inner surface) 14a, a step part 33, an inclination step part 34, and first and second groove parts (a plurality of groove parts) 36 and 37.

The inner circumferential surface 14a is formed on a circumference along the outer circumferential surface 26a of the probe 26 in a circumferential direction at a predetermined interval on an outside in the radial direction with respect to the outer circumferential surface 26a of the probe 26. In other words, the inner circumferential surface 14a is formed so as to surround the probe 26 at the outside on a surface that intersects the rotation axis 28 of the probe 26.

That is, for example, a slight gap S is formed in the radial direction between the outer circumferential surface 26a of the probe 26 and the inner circumferential surface 14a of the shoulder 14. The probe 26 penetrates movably in the axis direction through the penetration hole 31 of the shoulder 14.

The step part 33 projects, for example, radially outward from the inner circumferential surface 14a at an end part 14b on the side of the joint part 23 of the shoulder 14 and is formed in an annular shape so as to be recessed to the opposite side of the joint part 23.

The inclination step part 34 is formed in a circular truncated cone shape at an end part 14c on the opposite side of the joint part 23 of the shoulder 14, for example, so as to be recessed to the side of the joint part 23 and project in an inclined form at the outside in the radial direction from the inner circumferential surface 14a and away from the joint part 23.

For example, a first groove part 36 and a second groove part 37 are formed as a plurality of groove parts on an inner circumferential surface 14a of the shoulder 14. The first groove part 36 is formed at a position closer to the joint part 23 and at an interval in the axis direction with respect to the second groove part 37. The first groove part 36 includes a groove bottom surface 41, a first groove side surface 42, and a second groove side surface 43. In the first embodiment, two groove parts of the first groove part 36 and the second groove part 37 are shown as a plurality of groove parts as an example; however, the number of groove parts may be arbitrarily selected.

The groove bottom surface 41 is formed on a circumference along the inner circumferential surface 14a at a predetermined distance on an outside in the radial direction with respect to the inner circumferential surface 14a of the shoulder 14. The first groove side surface 42 is formed in a ring shape toward an inside in the radial direction to the inner circumferential surface 14a from the periphery of an opposite side (a side away from the joint part 23) of the joint part 23 (that is, the first workpiece 21, the second workpiece 22) in the axis direction of the groove bottom surface 41. The second groove side surface 43 is formed in a ring shape toward an inside in the radial direction to the inner circumferential surface 14a from the periphery of the joint part 23 side (a side close to the joint part 23) in the axis direction of the groove bottom surface 41.

The first groove side surface 42 and the second groove side surface 43 are formed to face each other at a predetermined interval in the axis direction. That is, the first groove part 36 is formed of the groove bottom surface 41, the first groove side surface 42, and the second groove side surface 43 in a U shape in a cross section so as to be recessed to the outside in the radial direction from the inner circumferential surface 14a.

The second groove part 37 is formed at a position away from the joint part 23 and at an interval in the axis direction with respect to the first groove part 36. Similarly to the first groove part 36, the second groove part 37 is formed of a groove bottom surface 45, a first groove side surface 46, and a second groove side surface 47 in a U shape in a cross section so as to be recessed to the outside in the radial direction from the inner circumferential surface 14a. The groove bottom surface 45, the first groove side surface 46, and the second groove side surface 47 are formed similarly to the groove bottom surface 41, the first groove side surface 42, and the second groove side surface 43 of the first groove part 36, respectively.

In this way, the first groove part 36 and the second groove part 37 are processed into the inner circumferential surface 14a of the shoulder 14, and thereby, the first groove part 36 and the second groove part 37 can be easily processed, for example, even in a case where the probe 26 is a hard-to-process material such as super hard alloy or ceramics.

The first groove part 36 and the second groove part 37 may be formed at an arbitrary position in the axis direction.

The probe 26 penetrates movably in the axis direction through the penetration hole 31 of the shoulder 14 as described above. In this state, for example, a slight gap S is formed in the radial direction between the outer circumferential surface 26a of the probe 26 and the inner circumferential surface 14a of the shoulder 14.

As a plurality of air chamber parts, for example, the first air chamber part 15 and the second air chamber part 16 are formed between the outer circumferential surface 26a of the probe 26 and the inner circumferential surface 14a of the shoulder 14.

The first air chamber part 15 is formed of the outer circumferential surface 26a of the probe 26 and the first groove part 36 in a rectangular shape in a cross section and in a hollow annular shape. The first air chamber part 15 is formed such that a first air chamber distance (distance) in the radial direction between the outer circumferential surface (an outer surface of the probe) 26a of the probe 26 and the groove bottom surface 41 (an inner surface of the shoulder) is L1.

The second air chamber part 16 is formed of the outer circumferential surface 26a of the probe 26 and the second groove part 37 in a rectangular shape in a cross section and in a hollow annular shape. The second air chamber part 16 is formed such that a second air chamber distance in the radial direction between the outer circumferential surface 26a of the probe 26 and an inner circumferential surface (that is, the groove bottom surface 45) of the shoulder 14 in the second air chamber part 16 is L2. The first air chamber distance L1 and the second air chamber distance L2 are formed, for example, to be the same distance.

The first air chamber part 15 and the second air chamber part 16 are formed in this order to be spaced by a first interval from each other at a position away from the joint part 23 in the axis direction. By arranging the first air chamber part 15 and the second air chamber part 16 in the axis direction, even in a case where the relative position of the probe 26 and the shoulder 14 is displaced in the axis direction, it is possible to facilitate the control of volumes of the first air chamber part 15 and the second air chamber part 16. That is, the control width of the position accuracy of the probe 26 can be widened, and the function of the friction stir welding can be stably exerted.

The first air chamber part 15 is located at a position closest to the joint part 23 (an end part 26b of the probe 26) and at a position closest to the end part 26b of the probe 26 among the plurality of air chamber parts (that is, the first air chamber part 15 and the second air chamber part 16). The first air chamber part 15 is formed to be spaced by a second interval at a position away from the joint part 23 with respect to the step part 33 (that is, a lower end of the penetration hole 31). The second air chamber part 16 is formed to be spaced by a third interval at a position close to the joint part 23 with respect to an upper end of the penetration hole 31.

The communication part 17, the first pathway part 18, and the second pathway part 19 are formed of the outer circumferential surface 26a of the probe 26 and a region 14d having the first interval, a region 14e having the second interval, and a region 14f having the third interval of the inner circumferential surface 14a of the shoulder 14, respectively, to have a gap S.

The communication part 17 causes the first air chamber part 15 and the second air chamber part 16 to communicate with each other in the axis direction by the gap S. Specifically, an end part on the side of the joint part 23 in the communication part 17 communicates with the first air chamber part 15 via a gap between an inner circumference of the first groove side surface 42 and the outer circumferential surface 26a of the probe 26 in the first air chamber part 15. An end part on the opposite side of the joint part 23 in the communication part 17 communicates with the second air chamber part 16 via a gap between the inner circumference of the second groove side surface 47 and the outer circumferential surface 26a of the probe 26 in the second air chamber part 16.

The communication part 17 is formed such that a communication part distance (distance) in the radial direction between the outer circumferential surface 26a of the probe 26 and the region 14d having the first interval is L3. The communication part distance L3 is formed to be smaller (narrower) than the first air chamber distance L1 and the second air chamber distance L2.

The first pathway part 18 causes the step part 33 and the first air chamber part 15 to communicate with each other in the axis direction by the gap S. Specifically, an end part on the side of the joint part 23 in the first pathway part 18 communicates with the step part 33. An end part on the opposite side of the joint part 23 in the first pathway part 18 communicates with the first air chamber part 15 via a gap between the inner circumference of the second groove side surface 43 and the outer circumferential surface 26a of the probe 26 in the first air chamber part 15.

The first pathway part 18 is formed such that a first pathway part distance (distance) in the radial direction between the outer circumferential surface 26a of the probe 26 and the region 14e having the second interval is L3 similarly to the communication part distance. In other words, the first pathway part 18 is formed of the end part 26b of the probe 26 and the end part 14b on the side of the joint part 23 in the shoulder 14. The first pathway part distance L3 is formed to be smaller (narrower) than the first air chamber distance L1.

The second pathway part 19 causes the inclination step part 34 and the second air chamber part 16 to communicate with each other in the axis direction by the gap S. Specifically, an end part on the opposite side of the joint part 23 in the second pathway part 19 communicates with the inclination step part 34. An end part on the side of the joint part 23 in the second pathway part 19 communicates with the second air chamber part 16 via a gap between the inner circumference of the first groove side surface 46 and the outer circumferential surface 26a of the probe 26 in the second air chamber part 16.

The second pathway part 19 is formed such that a second pathway part distance in the radial direction between the outer circumferential surface 26a of the probe 26 and the region 14f having the third interval is L3 similarly to the communication part distance. In other words, the second pathway part 19 is formed of a portion on the side of the probe shaft portion 25 in the probe 26 and the end part 14c on the opposite side of the joint part 23 in the shoulder 14. The second pathway part distance L3 is formed to be smaller (narrower) than the second air chamber distance L2.

That is, the first air chamber part 15 and the second air chamber part 16 are formed such that cross-sectional areas of the first air chamber part 15 and the second air chamber part 16 are larger than those of the communication part 17, the first pathway part 18, and the second pathway part 19. The first air chamber part 15 and the second air chamber part 16 are formed such that volumes of the first air chamber part 15 and the second air chamber part 16 are larger than those of the communication part 17, the first pathway part 18, and the second pathway part 19.

In the first embodiment, two air chambers of the first air chamber part 15 and the second air chamber part 16 are shown as a plurality of air chamber parts as an example; however, the number of air chamber parts may be arbitrarily selected.

Next, an example in which a cutting chip (for example, a burr or the like) that is generated when the friction stir welding is performed by a friction stir welding method of the friction stir welding apparatus 10 of the first embodiment is prevented from entering the gap S between the probe 26 and the shoulder 14 is described with reference to FIG. 1 and FIG. 2.

As shown in FIG. 1, the joint part 23 is arranged on the support tool 12 in a state where the first workpiece 21 and the second workpiece 22 are laminated. In this state, the joint part 23 is located at a position that corresponds to the probe 26 and the shoulder 14. An end part 26b of the probe 26 is arranged to be substantially flush with respect to the end part 14b of the shoulder 14.

Next, the drive mechanism is operated, the probe 26 and the shoulder 14 are lowered, the end part 14b of the shoulder 14 is caused to approach a position of a predetermined distance from the joint part 23, and the probe 26 and the shoulder 14 are rotated in accordance with the rotation axis 28 in the arrow A direction.

Here, the probe 26 and the shoulder 14 are set such that rotation numbers relative to the rotation axis 28 are different from each other. For example, the probe 26 is rotated at a high speed relative to the shoulder 14.

In this state, the probe 26 and shoulder 14 are further moved toward the joint part 23, and, for example, the end part 14b of the shoulder 14 is caused to come into slidable contact with the joint part 23. The joint part 23 is pressed by the end part 14b of the shoulder 14, and the joint part 23 is softened by frictional heat.

Subsequently, the end part 26b of the probe 26 is caused to come into slidable contact with the joint part 23 in a state of protruding from the end part 14b of the shoulder 14 to the joint part 23 side and pressing the joint part 23. Frictional heat is generated at the joint part 23 with which the end part 26b of the probe 26 comes into slidable contact. Accordingly, the joint part 23 is softened, and the probe 26 is buried in the joint part 23. Thereby, the second workpiece 22 and the first workpiece 21 are welded by the friction stir welding at the joint part 23 by the friction stir welding method of the friction stir welding apparatus 10.

In this way, in the friction stir welding method using the friction stir welding apparatus 10, as described above, the probe 26 and the shoulder 14 are set such that the rotation numbers are different from each other, and, for example, the probe 26 is rotated at a high speed relative to the shoulder 14. Accordingly, it is conceivable that heat is generated due to friction between the outer circumferential surface 26a of the probe 26 and the inner circumferential surface 14a of the shoulder 14.

Thereby, it is conceivable that, in a case where the cutting chip that is generated at the time of friction stir welding of the joint part 23 of the second workpiece 22 and the first workpiece 21 enters the gap S between the probe 26 and the shoulder 14, the fluidity of the cutting chip is enhanced by frictional heat. Therefore, it is conceivable that the cutting chip easily penetrates the gap S between the probe 26 and the shoulder 14, which may affect the quality of the joint part 23.

Therefore, according to the friction stir welding apparatus 10, the first air chamber part 15 and the second air chamber part 16 are formed between the outer circumferential surface 26a of the probe 26 and the inner circumferential surface 14a of the shoulder 14, and the communicating part 17 causes the first air chamber part 15 and the second air chamber part 16 to communicate with each other. Accordingly, the cutting chip that is generated at the time of friction stir welding of the second workpiece 22 and the first workpiece 21 at the joint part 23 enters the first air chamber part 15 via the first pathway part 18 from the step part 33 as indicated by an arrow B.

The first pathway part 18 is formed such that the first pathway part distance L3 is smaller than the first air chamber distance L1 of the first air chamber part 15. The first pathway part 18 is formed such that a cross-sectional area in a cross section perpendicular to the rotation axis 28 is smaller than that of the first air chamber part 15. Accordingly, the cutting chip enters the first air chamber part 15 from the first pathway part 18, and thereby, the pressure of the cutting chip is lowered due to a pressure loss.

The cutting chip that has entered the first air chamber part 15 enters the communication part 17 as indicated by an arrow C. The cutting chip that has entered the communication part 17 enters the second air chamber part 16 via the communication part 17 as indicated by an arrow D.

The communication part 17 is formed such that the communication part distance L3 is smaller than the second air chamber distance L2 of the second air chamber part 16. Accordingly, the cutting chip enters the second air chamber part 16 from the communication part 17, and thereby, the pressure of the cutting chip is lowered due to a pressure loss.

The cutting chip that has entered the second air chamber part 16 enters the second pathway part 19 from the second air chamber part 16 as indicated by an arrow E. The second pathway part 19 is formed such that the second pathway part distance L3 is smaller than the second air chamber distance L2 of the second air chamber part 16.

In this way, by causing the cutting chip to repeatedly enter the first air chamber part 15, the communication part 17, the second air chamber part 16, and the second pathway part 19 in order, for example, even the cutting chip having enhanced fluidity due to frictional heat can generate a pressure loss, and it is possible to sufficiently prevent the flow of the cutting chip. Thereby, it is possible to prevent the cutting chip that is generated at the time of friction stir welding of the second workpiece 22 and the first workpiece 21 at the joint part 23 from entering the gap S between the probe 26 and the shoulder 14. Accordingly, it is possible to improve the quality of the joint part 23 at which the second workpiece 22 and the first workpiece 21 are welded by the friction stir welding using the probe 26.

Further, according to the friction stir welding apparatus 10, the first pathway part 18 is formed of the end part 26b of the probe 26 and the end part 14b on the side of the joint part 23 in the shoulder 14. Further, the first pathway part distance L3 that is formed of the end part 26b of the probe 26 and the end part 14b of the shoulder 14 is formed to be smaller (narrower) than the first air chamber distance L1 of the first air chamber part 15.

Accordingly, it is possible to prevent the cutting chip that is generated at the time of friction stir welding of the second workpiece 22 and the first workpiece 21 at the joint part 23 from entering the first air chamber part 15 that is located at a position closest to the joint part 23 by the gap S of the first pathway part 18 even when the fluidity is enhanced by the frictional heat. Thereby, it is possible to further favorably prevent the cutting chip that is generated at the time of friction stir welding of the second workpiece 22 and the first workpiece 21 at the joint part 23 from entering the gap S between the probe 26 and the shoulder 14. Accordingly, it is possible to further favorably improve the quality of the joint part 23 at which the second workpiece 22 and the first workpiece 21 are welded by the friction stir welding using the probe 26.

Here, the first air chamber part 15 and the second air chamber part 16 are formed such that the groove bottom surface 41 and the groove bottom surface 45 are away from the inner circumferential surface 14a toward the outside in the radial direction. The frictional heat of the probe 26 and the shoulder 14 is generated at the outer circumferential surface 26a of the probe 26 and the inner circumferential surface 14a of the shoulder 14. Accordingly, the groove bottom surface 41 and the groove bottom surface 45 are formed at a position at the outside in the radial direction away from the frictional heat. Thereby, the cutting chip that has entered the first air chamber part 15 and the second air chamber part 16 can be guided by a centrifugal force toward the groove bottom surface 41 and the groove bottom surface 45 and can be moved away from the frictional heat to the outside in the radial direction. Accordingly, it is possible to enhance the viscosity of the cutting chip that has entered the first air chamber part 15 and the second air chamber part 16 and to reduce the fluidity of the cutting chip, and it is possible to further favorably prevent the cutting chip from entering the gap S between the probe 26 and the shoulder 14.

In the friction stir welding method of the friction stir welding apparatus 10, an example is described in which the probe 26 and the shoulder 14 are set such that the rotation numbers of the probe 26 and the shoulder 14 are different from each other, and, for example, the probe 26 is rotated at a high speed relative to the shoulder 14; however, the method is not limited thereto. As another example, for example, the probe 26 and the shoulder 14 may be rotated at the same rotation number. Even in this case, according to the friction stir welding apparatus 10, it is possible to favorably prevent the cutting chip that is generated at the time of friction stir welding of the second workpiece 22 and the first workpiece 21 at the joint part 23 from entering the gap S between the probe 26 and the shoulder 14. Accordingly, it is possible to further favorably improve the quality of the joint part 23 at which the second workpiece 22 and the first workpiece 21 are welded by the friction stir welding using the probe 26.

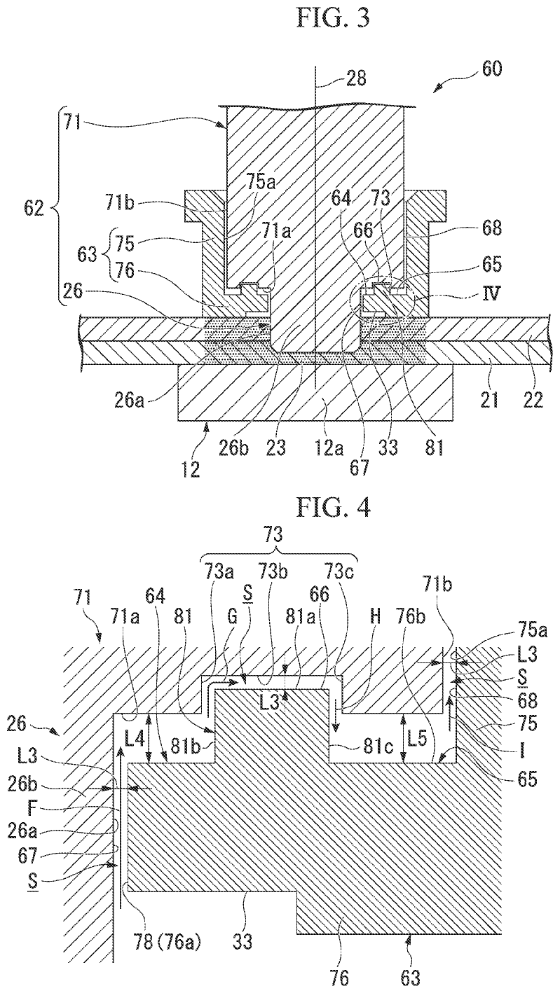

Next, a friction stir welding apparatus of second to ninth embodiments according to the present invention will be described with reference to FIG. 3 to FIG. 18. In the second to ninth embodiments, the same reference numerals are given to configurations that are the same as or similar to the configuration of the first embodiment, description thereof is omitted, and the differences are described.

### Second Embodiment

As shown in FIG. 3 and FIG. 4, a friction stir welding apparatus 60 is an apparatus in which the first and second air chamber parts 15 and 16 and the communication part 17 of the first embodiment are mainly replaced by first and second air chamber parts (a plurality of air chambers) 64 and 65 and a communication part 66, respectively. The first air chamber part 15, the second air chamber part 16, and the communication part 17 of the first embodiment are arranged in the axis direction. On the other hand, the first air chamber part 64, the second air chamber part 65, and the communication part 66 of the second embodiment are arranged in the radial direction.

The friction stir welding apparatus 60 includes a support tool 12, a friction stir welding tool 62, a shoulder 63, first and second air chamber parts 64 and 65, a communication part 66, first and second pathway parts 67 and 68, and a drive mechanism (not shown).

The friction stir welding tool 62 includes a probe shaft part 71 and a probe 26. In the probe shaft part 71, a groove part 73 having an annular shape is formed on an end surface (an outer surface of the probe 26) 71a on the side of the joint part 23. The groove part 73 has a groove inner upper surface 73b, a groove inner side surface 73a, and a groove outer side surface 73c. The groove part 73 is formed of the groove inner upper surface 73b, the groove inner side surface 73a, and the groove outer side surface 73c in a U shape in a cross section so as to be recessed from an end surface (an outer surface of the probe) 71a of the probe shaft part 71 toward the opposite side of the joint part 23.

In the probe 26 and the probe shaft part 71, an outer circumferential surface (outer circumference) 26a of the probe 26 and an outer circumferential surface 71b of the probe shaft part 71 are surrounded in the circumferential direction at the outside in the radial direction by a shoulder 63.

The shoulder 14 includes, for example, a shoulder cylinder part 75 and a shoulder bottom part (an end part on the side of the joint part 23 in the shoulder 63) 76. The shoulder cylinder part 75 is formed in a cylindrical shape, and a cylinder inner circumferential surface 75a is formed, for example, to be spaced by a slight gap S in the radial direction with respect to the outer circumferential surface 71b of the probe shaft part 71. The shoulder bottom part 76 is formed in a circular plate shape at the end part on the side of the joint part 23 in the shoulder cylinder part 75, and a penetration hole 78 is formed at the center of the shoulder bottom part 76.

The shoulder bottom part 76 includes a bottom inner circumferential surface (that is, an inner surface of the shoulder) 76a, a step part 33, and a protrusion part 81. The bottom inner circumferential surface 76a is formed, for example, to be spaced by a slight gap S in the radial direction with respect to the outer circumferential surface 26a of the probe 26.

That is, the friction stir welding tool 62 (that is, the probe shaft part 71 and the probe 26) penetrates through the shoulder 63 so as to be movable in the axis direction.

The protrusion part 81 protrudes in an annular shape toward the groove part 73 from an inner surface (an inner surface of the shoulder) 76b that faces the end surface 71a of the probe shaft part 71 in the shoulder bottom part 76. The protrusion part 81 has a protrusion top surface 81a, a protrusion inner side surface 81b, and a protrusion outer side surface 81c.

In this way, the protrusion part 81 is processed into the shoulder bottom part 76, and thereby, the first groove the protrusion part 81 can be easily processed, for example, even in a case where the probe shaft part 71 is a hard-to-process material such as super hard alloy or ceramics.

The protrusion top surface 81a is arranged to be spaced by a slight gap S in the axis direction with respect to the groove inner upper surface 73b of the groove part 73. The protrusion inner side surface 81b is arranged to be spaced by a slight gap S in the radial direction with respect to the groove inner side surface 73a of the groove part 73. The protrusion outer side surface 81c is arranged to be spaced by a slight gap S in the radial direction with respect to the groove outer side surface 73c of the groove part 73.

As described above, the first air chamber part 64 and the second air chamber part 65 are formed between the outer surface (specifically, the end surface 71a of the probe shaft part 71) of the probe 26 and the inner surface (specifically, the inner surface 76b of the shoulder bottom part 76) of the shoulder 63.

The first air chamber part 64 is formed of the outer circumferential surface 26a of the probe 26, the end surface 71a of the probe shaft part 71, the protrusion inner side surface 81b of the protrusion part 81, and the inner surface 76b of the shoulder bottom part 76 in a rectangular shape in a cross section and in a hollow annular shape. The first air chamber part 64 is formed such that a first air chamber distance (distance) in the axis direction between the end surface 71a (the outer surface of the probe) of the probe shaft part 71 and the inner surface 76b (the inner surface of the shoulder) of the shoulder bottom part 76 is L4.

The second air chamber part 65 is formed of the protrusion outer side surface 81c of the protrusion part 81, the end surface 71a of the probe shaft part 71, the cylinder inner circumferential surface 75a of the shoulder cylinder part 75, and the inner surface 76b of the shoulder bottom part 76 in a rectangular shape in a cross section and in a hollow annular shape. The second air chamber part 65 is formed such that a second air chamber distance in the axis direction between the end surface 71a of the probe shaft part 71 and the inner surface 76b of the shoulder bottom part 76 is L5.

The first air chamber part 64 and the second air chamber part 65 are formed in this order to be spaced by a first interval from each other at a position away from the probe 26 in the radial direction. That is, the first air chamber part 64 is located at a position closest to the end part 26b of the probe 26 among the plurality of air chamber parts (that is, the first air chamber part 64 and the second air chamber part 65). The first air chamber part 64 is formed to be spaced by a second interval at a position away from the joint part 23 with respect to the step part 33 (that is, a lower end of the penetration hole 78) in the axis direction. The second air chamber part 65 is formed to be spaced by a first interval at the outside in the radial direction with respect to the first air chamber part 64.

The first pathway part 67 is formed of the bottom inner circumferential surface 76a of the shoulder bottom part 76 and the outer circumferential surface 26a of the probe 26 in a gap S. The communication part 66 is formed of the groove part 73 and the protrusion part 81 in the gap S and in a U shape in a cross section. The second pathway part 68 is formed of the outer circumferential surface 71b of the probe shaft part 71 and the cylinder inner circumferential surface 75a of the shoulder cylinder part 75 in the gap S.

The communication part 66 causes the first air chamber part 64 and the second air chamber part 65 to communicate with each other substantially in the radial direction by the gap S. The communication part 66 is formed in a U shape in a cross section, and thereby, the first air chamber part 64, the communication part 66, and the second air chamber part 65 are formed in a labyrinth shape.

The communication part 66 is formed such that a communication part distance (distance) between the groove part 73 and the protrusion part 81 is L3.

The communication part distance L3 is formed to be smaller (narrower) than the first air chamber distance L4 and the second air chamber distance L5.

The first pathway part 67 causes the step part 33 and the first air chamber part 64 to communicate with each other in the axis direction by the gap S. The first pathway part 67 is formed such that a first pathway part distance (distance) in the radial direction between the outer circumferential surface 26a of the probe 26 and the bottom inner circumferential surface 76a of the shoulder bottom part 76 is L3 similarly to the communication part distance. The first pathway part distance L3 is formed to be smaller (narrower) than the first air chamber distance L4. The first air chamber part 64 is formed to be larger (broader) than the first pathway part distance L3 in a cross section perpendicular to the rotation axis 28.

The second pathway part 67 causes the outside of the shoulder 63 and the second air chamber part 65 to communicate with each other in the axis direction by the gap S. The second pathway part 68 is formed such that a second pathway part distance in the radial direction between the outer circumferential surface 71b of the probe shaft part 71 and the cylinder inner circumferential surface 75a of the shoulder cylinder part 75 is L3 similarly to the communication part distance. The second pathway part distance L3 is formed to be smaller (narrower) than the second air chamber distance L5.

That is, the first air chamber part 64 and the second air chamber part 65 are formed to have a larger cross-sectional area compared to the communication part 66, the first pathway part 67, and the second pathway part 68. The first air chamber part 64 and the second air chamber part 65 are formed to have a larger volume compared to the communication part 66, the first pathway part 67, and the second pathway part 68.

In the second embodiment, an example is described in which two air chambers of the first air chamber part 64 and the second air chamber part 65 are a plurality of air chamber parts; however, the number of air chambers may be arbitrarily selected.

Next, an example in which a cutting chip (for example, a burr or the like) that is generated when the friction stir welding is performed by a friction stir welding method of the friction stir welding apparatus 60 of the second embodiment is prevented from entering the gap S between the probe 26 and the shoulder 63 is described with reference to FIG. 3 and FIG. 4.

According to the friction stir welding apparatus 60, the first air chamber part 64 and the second air chamber part 65 are formed between the outer surface of the probe 26 and the inner surface of the shoulder 63, and the communication part 66 causes the first air chamber part 64 and the second air chamber part 65 to communicate with each other.

Accordingly, the cutting chip that is generated at the time of friction stir welding of the second workpiece 22 and the first workpiece 21 at the joint part 23 enters and is accumulated in the first air chamber part 64 via the first pathway part 67 from the step part 33 as indicated by an arrow F.

The first pathway part 67 is formed such that the first pathway part distance L3 is smaller than the first air chamber distance L4 of the first air chamber part 64. The first air chamber part 64 is formed to be larger than the first pathway part distance L3 in a cross section perpendicular to the rotation axis 28. Accordingly, the cutting chip enters the first air chamber part 64 from the first pathway part 67, and thereby, the pressure of the cutting chip is lowered due to a pressure loss.

The cutting chip that is accumulated in the first air chamber part 64 enters the communication part 66 as indicated by an arrow G.

The cutting chip that has entered the communication part 66 enters and is accumulated in the second air chamber part 65 via the communication part 66 as indicated by an arrow H.

The communication part 66 is formed such that the communication part distance L3 is smaller than the second air chamber distance L5 of the second air chamber part 65. Accordingly, the cutting chip that is accumulated in the first air chamber part 64 enters the second air chamber part 65 from the communication part 66, and thereby, the pressure of the cutting chip is lowered due to a pressure loss.

The cutting chip that is accumulated in the second air chamber part 65 enters the second pathway part 68 from the second air chamber part 65 as indicated by an arrow I. The second pathway part 68 is formed such that the second pathway part distance L3 is smaller than the second air chamber distance L5 of the second air chamber part 65. In this way, by causing the cutting chip to repeatedly enter the first air chamber part 64, the communication part 66, the second air chamber part 65, and the second pathway part 68 in order, for example, even the cutting chip having enhanced fluidity due to frictional heat as in the first embodiment can generate a pressure loss, and it is possible to sufficiently prevent the flow of the cutting chip. Thereby, it is possible to prevent the cutting chip that is generated at the time of friction stir welding of the second workpiece 22 and the first workpiece 21 at the joint part 23 from entering the gap S between the probe 26 and the shoulder 63. Accordingly, it is possible to improve the quality of the joint part 23 at which the second workpiece 22 and the first workpiece 21 are welded by the friction stir welding using the probe 26.

Further, according to the friction stir welding apparatus 60, the first pathway part 67 is formed of the end part 26b of the probe 26 and the shoulder bottom part 76 (that is, an end part of the shoulder 63). Further, the first pathway part distance L3 that is formed of the end part 26b of the probe 26 and the bottom inner circumferential surface 76a is formed to be smaller (narrower) than the first air chamber distance L4 of the first air chamber part 64.

Accordingly, it is possible to prevent the cutting chip that is generated at the time of friction stir welding of the second workpiece 22 and the first workpiece 21 at the joint part 23 from entering the first air chamber part 64 that is located at a position closest to the joint part 23 by the gap S of the first pathway part 67 even when the fluidity is enhanced by the frictional heat. Thereby, it is possible to further favorably prevent the cutting chip that is generated at the time of friction stir welding of the second workpiece 22 and the first workpiece 21 at the joint part 23 from entering the gap S between the probe 26 and the shoulder 63. Accordingly, it is possible to further favorably improve the quality of the joint part 23 at which the second workpiece 22 and the first workpiece 21 are welded by the friction stir welding using the probe 26.

Here, the cutting chip enters the first air chamber part 64 from the first pathway part 67 in the axis direction as indicated by an arrow F. The cutting chip that is accumulated in the first air chamber part 64 enters the communication part 66 from the first air chamber part 64 and is guided in the communication part 66 such that the entering direction is changed from the axis direction to the radial direction as indicated by an arrow G. Accordingly, it is possible to cause the cutting chip that has entered the first air chamber part 64 to hit against the end surface 71a of the probe shaft part 71 in the first air chamber part 64, and it is possible to accumulate the cutting chip in the first air chamber part 64.

The cutting chip that has entered the communication part 66 enters and is accumulated in the second air chamber part 65 via the communication part 66 as indicated by the arrow H. The cutting chip that is accumulated in the second air chamber part 65 is guided from the second air chamber part 65 to the second pathway part 68 as indicated by an arrow I in an entering direction (that is, an inverted axis direction) different from the entering direction to the second air chamber part 65. Accordingly, it is possible to cause the cutting chip that has entered the second air chamber part 65 to hit against the inner surface 76b of the shoulder bottom part 76 in the second air chamber part 65, and it is possible to accumulate the cutting chip in the second air chamber part 65.

Thereby, it is possible to cause the cutting chip to hardly enter the communication part 66 and the second pathway part 68 from the first air chamber part 64 and the second air chamber part 65, respectively, until the first air chamber part 64 and the second air chamber part 65 are filled by the cutting chip. Accordingly, it is possible to further favorably prevent the cutting chip from entering the gap S between the probe 26 and the shoulder 63.

### Third Embodiment

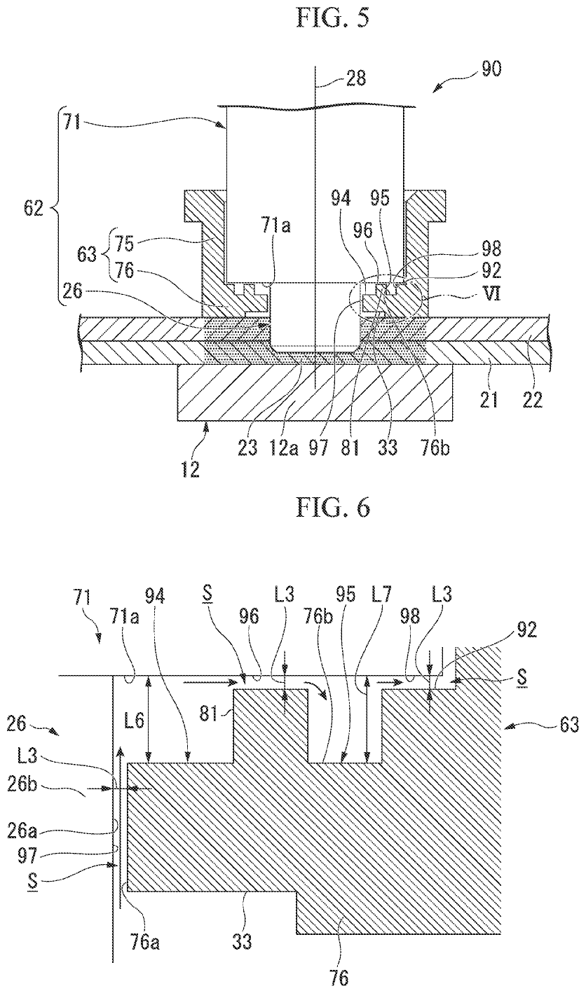

As shown in FIG. 5 and FIG. 6, the friction stir welding apparatus 90 is an apparatus in which, mainly, the groove part 73 having an annular shape is removed from the end surface 71a of the probe shaft part 71 of the second embodiment, and a step part 92 in addition to the protrusion part 81 is formed on the inner surface 76b of the shoulder bottom part 76 of the second embodiment.

The protrusion part 81 and the step part 92 are processed into the shoulder bottom part 76, and thereby, the protrusion part 81 and the step part 92 can be easily processed, for example, even in a case where the probe shaft part 71 is a hard-to-process material such as super hard alloy or ceramics.

A first air chamber part 94, a communication part 96, and a second air chamber part 95 of a third embodiment are arranged toward the outside in the radial direction in order, similarly to the first air chamber part 64, the communication part 66, and the second air chamber part 65 of the second embodiment.

The first air chamber part 94 is formed such that a first air chamber distance (distance) is L6. The second air chamber part 95 is formed such that a second air chamber distance is L7. The communication part 96 is formed such that a communication part distance (distance) in the axis direction between the end surface 71a of the probe shaft part 71 and the protrusion part 81 is L3. The communication part distance L3 is formed to be smaller (narrower) than the first air chamber distance L6 and the second air chamber distance L7.

The first pathway part 97 is formed such that a first pathway part distance (distance) in the radial direction between the outer circumferential surface 26a of the probe 26 and the bottom inner circumferential surface 76a of the shoulder bottom part 76 is L3 similarly to the communication part distance.

The first pathway part distance L3 is formed to be smaller (narrower) than the first air chamber distance L6. The first air chamber part 94 is formed to be larger (broader) than the first pathway part distance L3 in a cross section perpendicular to the rotation axis 28.

The second pathway part 98 is formed such that a second pathway part distance in the axis direction between the end surface 71a of the probe shaft part 71 and the step part 92 is L3 similarly to the communication part distance. The second pathway part distance L3 is formed to be smaller (narrower) than the second air chamber distance L7.

That is, the first air chamber part 94 and the second air chamber part 95 are formed to have a larger cross-sectional area compared to the communication part 96, the first pathway part 97, and the second pathway part 98. The first air chamber part 94 and the second air chamber part 95 are formed to have a larger volume compared to the communication part 96, the first pathway part 97, and the second pathway part 98.

Next, an example in which a cutting chip (for example, a burr or the like) that is generated when the friction stir welding is performed by a friction stir welding method of the friction stir welding apparatus 90 of the third embodiment is prevented from entering the gap S between the probe 26 and the shoulder 63 is described with reference to FIG. 5 and FIG. 6.

According to the friction stir welding apparatus 90, the cutting chip that is generated at the time of friction stir welding of the second workpiece 22 and the first workpiece 21 at the joint part 23 enters and is accumulated in the first air chamber part 94 via the first pathway part 97 from the step part 33 as indicated by the arrow.

The first pathway part 97 is formed such that the first pathway part distance L3 is smaller than the first air chamber distance L6 of the first air chamber part 94. The first air chamber part 94 is formed to be larger than the first pathway part distance L3 in a cross section perpendicular to the rotation axis 28. Accordingly, the cutting chip enters the first air chamber part 94 from the first pathway part 97, and thereby, the pressure of the cutting chip is lowered due to a pressure loss.

Further, the cutting chip that is accumulated in the first air chamber part 94 enters the communication part 96 as indicated by the arrow. The cutting chip that has entered the communication part 96 enters and is accumulated in the second air chamber part 95 via the communication part 96 as indicated by the arrow.

The communication part 96 is formed such that the communication part distance L3 is smaller than the second air chamber distance L7 of the second air chamber part 95. Accordingly, the cutting chip enters the second air chamber part 95 from the communication part 96, and thereby, the pressure of the cutting chip is lowered due to a pressure loss.

The cutting chip that is accumulated in the second air chamber part 95 enters the second pathway part 98 from the second air chamber part 95 as indicated by the arrow. The second pathway part 98 is formed such that the second pathway part distance L3 is smaller than the second air chamber distance L7 of the second air chamber part 95.

In this way, by causing the cutting chip to repeatedly enter the first air chamber part 94, the communication part 96, the second air chamber part 95, and the second pathway part 98 in order, for example, even the cutting chip having enhanced fluidity due to frictional heat as in the second embodiment can generate a pressure loss, and it is possible to sufficiently prevent the flow of the cutting chip. Thereby, it is possible to prevent the cutting chip that is generated at the time of friction stir welding of the second workpiece 22 and the first workpiece 21 at the joint part 23 from entering the gap S between the probe 26 and the shoulder 63. Accordingly, it is possible to improve the quality of the joint part 23 at which the second workpiece 22 and the first workpiece 21 are welded by the friction stir welding using the probe 26.

Further, according to the friction stir welding apparatus 90, the first pathway part 97 is formed of the end part 26b of the probe 26 and the shoulder bottom part 76 (that is, an end part of the shoulder 63). Further, the first pathway part distance L3 that is formed of the end part 26b of the probe 26 and the bottom inner circumferential surface 76a is formed to be smaller (narrower) than the first air chamber distance L6 of the first air chamber part 94.

Accordingly, it is possible to prevent the cutting chip that is generated at the time of friction stir welding of the second workpiece 22 and the first workpiece 21 at the joint part 23 from entering the first air chamber part 94 that is located at a position closest to the joint part 23 by the gap S of the first pathway part 97 even when the fluidity is enhanced by the frictional heat. Thereby, it is possible to further favorably prevent the cutting chip that is generated at the time of friction stir welding of the second workpiece 22 and the first workpiece 21 at the joint part 23 from entering the gap S between the probe 26 and the shoulder 63. Accordingly, it is possible to further favorably improve the quality of the joint part 23 at which the second workpiece 22 and the first workpiece 21 are welded by the friction stir welding using the probe 26.

Here, the cutting chip enters the first air chamber part 94 from the first pathway part 97 in the axis direction as indicated by the arrow. The cutting chip that is accumulated in the first air chamber part 94 is guided to the communication part 96 from the first air chamber part 94 in the radial direction such that the entering direction is different as indicated by the arrow. Accordingly, it is possible to cause the cutting chip that has entered the first air chamber part 94 to hit against the end surface 71a of the probe shaft part 71 in the first air chamber part 94, and it is possible to accumulate the cutting chip in the first air chamber part 64.

Thereby, it is possible to cause the cutting chip to hardly enter the communication part 96 from the first air chamber part until the first air chamber part 94 is filled by the cutting chip. Accordingly, it is possible to further favorably prevent the cutting chip from entering the gap S between the probe 26 and the shoulder 63.

### Fourth Embodiment

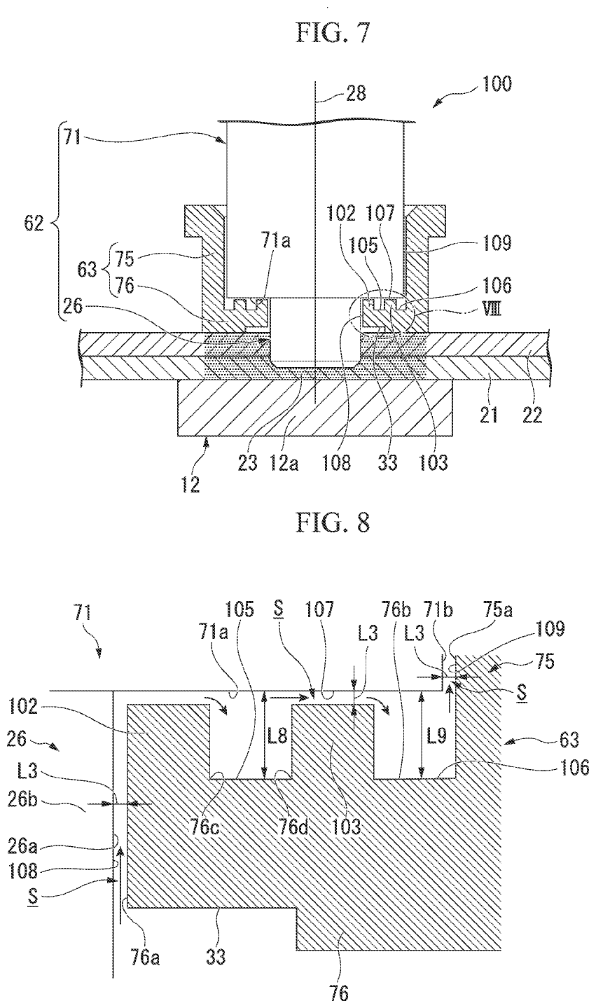

As shown in FIG. 7 and FIG. 8, a friction stir welding apparatus 100 is an apparatus in which, mainly, the groove part 73 having an annular shape is removed from the end surface 71a of the probe shaft part 71 of the second embodiment, and the protrusion part 81 of the second embodiment is replaced by a first protrusion part 102 and a second protrusion part 103.

The first protrusion part 102 and the second protrusion part 103 are processed into the shoulder bottom part 76, and thereby, the first protrusion part 102 and the second protrusion part 103 can be easily processed, for example, even in a case where the probe shaft part 71 is a hard-to-process material such as super hard alloy or ceramics.

A first air chamber part 105, a communication part 107, and a second air chamber part 106 of the fourth embodiment are arranged toward the outside in the radial direction in order, similarly to the first air chamber part 64, the communication part 66, and the second air chamber part 65 of the second embodiment.

The first protrusion part 102 protrudes, at an inner surface 76b of the shoulder bottom part 76, in an annular shape toward the end surface 71a of the probe shaft part 71 from an inner circumferential end 76c in the radial direction. The second protrusion part 103 protrudes, at the inner surface 76b of the shoulder bottom part 76, in an annular shape toward the end surface 71a of the probe shaft part 71 from a portion 76d on the outside in the radial direction relative to the first protrusion part 102.

The first air chamber part 105 is formed such that a first air chamber distance (distance) is L8. The second air chamber part 106 is formed such that a second air chamber distance is L9. The communication part 107 is formed such that a communication part distance (distance) in the axis direction between the end surface 71a of the probe shaft part 71 and the second protrusion part 103 is L3. The communication part distance L3 is formed to be smaller (narrower) than the first air chamber distance L8 and the second air chamber distance L9.

The first pathway part 108 is formed such that each of a distance in the radial direction between the outer circumferential surface 26a of the probe 26 and the bottom inner circumferential surface 76a of the shoulder bottom part 76 and a distance in the axis direction between the end surface 71a of the probe shaft part 71 and the first protrusion part 102 is a first pathway part distance (distance). That is, the first pathway part 108 has a portion formed of the end part 26b of the probe 26 and the shoulder bottom part 76 (that is, the end part of the shoulder 63). The first pathway part distance is formed to be L3 similarly to the communication part distance. The first pathway part distance L3 is formed to be smaller (narrower) than the first air chamber distance L8.

The second pathway part 109 is formed such that a second pathway part distance in the radial direction between the outer circumferential surface 71b of the probe shaft part 71 and the cylinder inner circumferential surface 75a of the shoulder cylinder part 75 is L3 similarly to the communication part distance. The second pathway part distance L3 is formed to be smaller (narrower) than the second air chamber distance L9.

That is, the first air chamber part 105 and the second air chamber part 106 are formed to have a larger cross-sectional area compared to the communication part 107, the first pathway part 108, and the second pathway part 109. The first air chamber part 105 and the second air chamber part 106 are formed to have a larger volume compared to the communication part 107, the first pathway part 108, and the second pathway part 109.

Next, an example in which a cutting chip (for example, a burr or the like) that is generated when the friction stir welding is performed by a friction stir welding method of the friction stir welding apparatus 100 of the fourth embodiment is prevented from entering the gap S between the probe 26 and the shoulder 63 is described with reference to FIG. 7 and FIG. 8.

According to the friction stir welding apparatus 100, the cutting chip that is generated at the time of friction stir welding of the second workpiece 22 and the first workpiece 21 at the joint part 23 enters and is accumulated in the first air chamber part 105 via the first pathway part 108 from the step part 33 as indicated by the arrow. The first pathway part 108 is formed such that the first pathway part distance L3 is smaller than the first air chamber distance L8 of the first air chamber part 105. Accordingly, the cutting chip enters the first air chamber part 105 from the first pathway part 108, and thereby, the pressure of the cutting chip is lowered due to a pressure loss.

Further, the cutting chip that is accumulated in the first air chamber part 105 enters the communication part 107 as indicated by the arrow. The cutting chip that has entered the communication part 107 enters and is accumulated in the second air chamber part 106 via the communication part 107 as indicated by the arrow.

The communication part 107 is formed such that the communication part distance L3 is smaller than the second air chamber distance L9 of the second air chamber part 106. Accordingly, the cutting chip enters the second air chamber part 106 from the communication part 107, and thereby, the pressure of the cutting chip is lowered due to a pressure loss.

The cutting chip that is accumulated in the second air chamber part 106 enters the second pathway part 109 from the second air chamber part 106 as indicated by the arrow. The second pathway part 109 is formed such that the second pathway part distance L3 is smaller than the second air chamber distance L9 of the second air chamber part 106.

In this way, by causing the cutting chip to repeatedly enter the first air chamber part 105, the communication part 107, the second air chamber part 106, and the second pathway part 109 in order, for example, even the cutting chip having enhanced fluidity due to frictional heat as in the second embodiment can generate a pressure loss, and it is possible to sufficiently prevent the flow of the cutting chip. Thereby, it is possible to prevent the cutting chip that is generated at the time of friction stir welding of the second workpiece 22 and the first workpiece 21 at the joint part 23 from entering the gap S between the probe 26 and the shoulder 63. Accordingly, it is possible to improve the quality of the joint part 23 at which the second workpiece 22 and the first workpiece 21 are welded by the friction stir welding using the probe 26.

Further, according to the friction stir welding apparatus 100, the first pathway part 108 has a portion that is formed of the end part 26b of the probe 26 and the shoulder bottom part 76 (that is, an end part of the shoulder 63). Further, the first pathway part distance L3 that is formed of the end part 26b of the probe 26 and the bottom inner circumferential surface 76a is formed to be smaller (narrower) than the first air chamber distance L8 of the first air chamber part 105.

Accordingly, it is possible to prevent the cutting chip that is generated at the time of friction stir welding of the second workpiece 22 and the first workpiece 21 at the joint part 23 from entering the first air chamber part 105 that is located at a position closest to the joint part 23 by the gap S of the first pathway part 108 even when the fluidity is enhanced by the frictional heat. Thereby, it is possible to further favorably prevent the cutting chip that is generated at the time of friction stir welding of the second workpiece 22 and the first workpiece 21 at the joint part 23 from entering the gap S between the probe 26 and the shoulder 63. Accordingly, it is possible to further favorably improve the quality of the joint part 23 at which the second workpiece 22 and the first workpiece 21 are welded by the friction stir welding using the probe 26.

Here, according to the friction stir welding apparatus 100, the first protrusion part 102 protrudes in an annular shape toward the end surface 71a of the probe shaft part 71 from the inner circumferential end 76c of the shoulder bottom part 76. Accordingly, the first pathway part 108 is formed to be large in the axis direction along the outer circumferential surface 26a of the probe 26. Thereby, the cutting chip that has entered the first pathway part 108 can be placed in the vicinity of the frictional heat of the outer circumferential surface 26a of the probe 26 and the bottom inner circumferential surface 76a of the shoulder bottom part 76. Accordingly, it is possible to prevent fixation of the cutting chip by keeping the cutting chip at a suitable high temperature. As a result, it is possible to facilitate maintenance accompanied by disassembly of the probe 26 and the shoulder 63.

### Fifth Embodiment

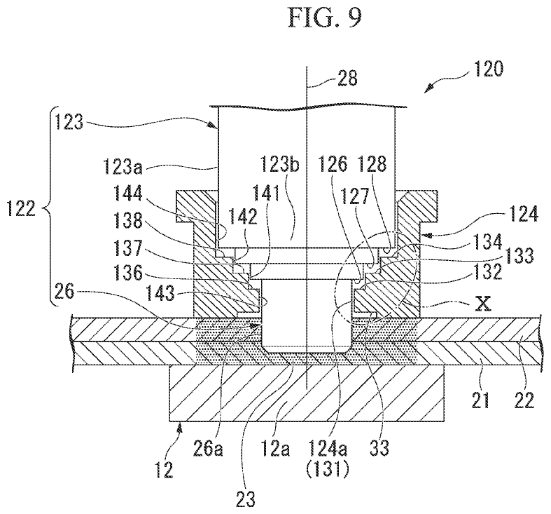

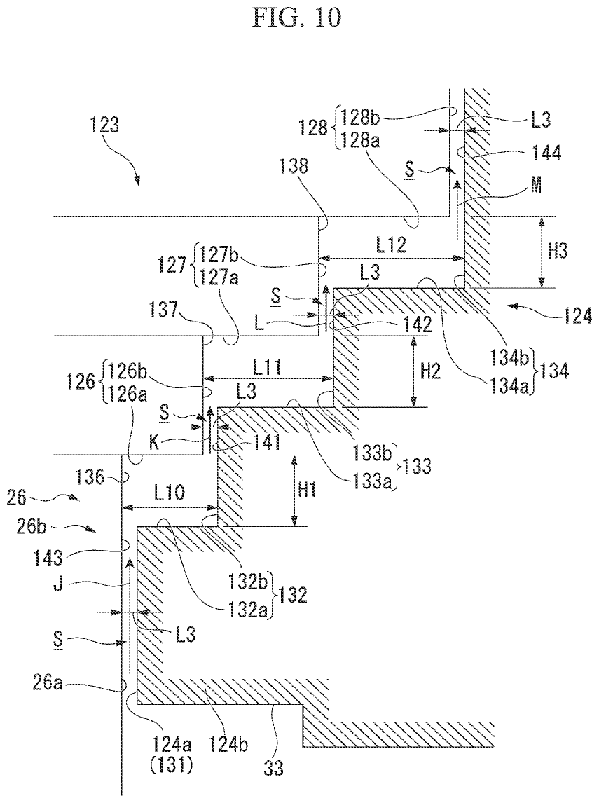

As shown in FIG. 9 and FIG. 10, a friction stir welding apparatus 120 is an apparatus in which an outer circumferential surface (outer surface) 123a of a probe shaft part (probe) 123 and an inner circumferential surface (inner surface) 124a of a shoulder 124 are intermittently radially enlarged from the side of the joint part 23 toward the opposite side in the axis direction.

The probe shaft part 123 includes a first protrusion enlarged diameter portion 126, a second protrusion enlarged diameter portion 127, and a third protrusion enlarged diameter portion 128 on the outer circumferential surface 123a in an end part 123b on the side of the joint part 23. The first protrusion enlarged diameter portion 126, the second protrusion enlarged diameter portion 127, and the third protrusion enlarged diameter portion 128 are intermittently radially enlarged from the side of the joint part 23 toward the opposite side.

Specifically, the first protrusion enlarged diameter portion 126 is radially enlarged in a protrusion shape to the outside in the radial direction relative to the outer circumferential surface 26a of the probe 26. The first protrusion enlarged diameter portion 126 has a first protrusion end surface 126a and a first protrusion outer circumferential surface 126b. The second protrusion enlarged diameter portion 127 is radially enlarged in a protrusion shape to the outside in the radial direction relative to the first protrusion outer circumferential surface 126b. The second protrusion enlarged diameter portion 127 has a second protrusion end surface 127a and a second protrusion outer circumferential surface 127b. The third protrusion enlarged diameter portion 128 is radially enlarged in a protrusion shape to the outside in the radial direction relative to the second protrusion outer circumferential surface 127b. The third protrusion enlarged diameter portion 128 has a third protrusion end surface 128a and a third protrusion outer circumferential surface 128b. The third protrusion outer circumferential surface 128b is a portion that forms part of the outer circumferential surface 123a of the probe shaft part 123.

A penetration hole 131 penetrates through the shoulder 124, and thereby, the shoulder 124 has an inner circumferential surface 124a. The shoulder 124 has a first recess enlarged diameter portion 132, a second recess enlarged diameter portion 133, and a third recess enlarged diameter portion 134 that are formed on the inner circumferential surface 124a. The first recess enlarged diameter portion 132, the second recess enlarged diameter portion 133, and the third recess enlarged diameter portion 134 are intermittently radially enlarged from the side of the joint part 23 toward the opposite side. Specifically, the first recess enlarged diameter portion 132 is radially enlarged to the outside in the radial direction relative to the inner circumferential surface 124a of the shoulder 124. The first recess enlarged diameter portion 132 has a first recess end surface 132a and a first recess inner circumferential surface 132b. The second recess enlarged diameter portion 133 is radially enlarged to the outside in the radial direction relative to the first recess inner circumferential surface 132b. The second recess enlarged diameter portion 133 has a second recess end surface 133a and a second recess inner circumferential surface 133b. The third recess enlarged diameter portion 134 is radially enlarged to the outside in the radial direction relative to the second recess inner circumferential surface 133b. The third recess enlarged diameter portion 134 has a third recess end surface 134a and a third recess inner circumferential surface 134b.

A probe 26 of a friction stir welding tool 122 penetrates through the penetration hole 131 of the shoulder 124. The first protrusion enlarged diameter portion 126, the second protrusion enlarged diameter portion 127, and the third protrusion enlarged diameter portion 128 of the probe shaft part 123 of the friction stir welding tool 122 are fitted to the first recess enlarged diameter portion 132, the second recess enlarged diameter portion 133, and the third recess enlarged diameter portion 134 of the shoulder 124, respectively.

A first air chamber part 136 is formed of the outer circumferential surface 26a of the probe 26, the first protrusion end surface 126a, the first recess inner circumferential surface 132b, and the first recess end surface 132a in a state where the first protrusion enlarged diameter portion 126 is fitted to the first recess enlarged diameter portion 132. The first air chamber part 136 is formed in a rectangular shape in a cross section and in a hollow annular shape.

The first air chamber part 136 is formed such that a first air chamber distance (distance) in the radial direction between the outer circumferential surface (an outer surface of the probe) 26a of the probe 26 and the first recess inner circumferential surface (an inner surface of the shoulder) 132b is L10. The first air chamber part 136 is formed such that a distance in the axis direction between the first protrusion end surface 126a and the first recess end surface 132a is H1.

A second air chamber part 137 is formed of the first protrusion outer circumferential surface 126b, the second protrusion end surface 127a, the second recess inner circumferential surface 133b, and the second recess end surface 133a in a state where the second protrusion enlarged diameter portion 127 is fitted to the second recess enlarged diameter portion 133. The second air chamber part 137 is formed in a rectangular shape in a cross section and in a hollow annular shape. The second air chamber part 137 is located at a position away from the joint part 23 in the axis direction relative to the first air chamber part 136 and is formed at the outside in the radial direction relative to the first air chamber part 136.

The second air chamber part 137 is formed such that a second air chamber distance in the radial direction between the first protrusion outer circumferential surface 126b and the inner circumferential surface (that is, the second recess inner circumferential surface 133b) of the shoulder 124 in the second air chamber part 137 is L11. The second air chamber part 137 is formed such that a distance in the axis direction between the second protrusion end surface 127a and the second recess end surface 133a is H2.

A third air chamber part 138 is formed of the second protrusion outer circumferential surface 127b, the third protrusion end surface 128a, the third recess inner circumferential surface 134b, and the third recess end surface 134a in a state where the third protrusion enlarged diameter portion 128 is fitted to the third recess enlarged diameter portion 134. The third air chamber part 138 is formed in a rectangular shape in a cross section and in a hollow annular shape. The third air chamber part 138 is located at a position away from the joint part 23 in the axis direction relative to the second air chamber part 137 and is formed at the outside in the radial direction relative to the second air chamber part 137.

The third air chamber part 138 is formed such that a third air chamber distance in the radial direction between the second protrusion outer circumferential surface 127b and the inner circumferential surface (that is, the third recess inner circumferential surface 134b) of the shoulder 124 in the third air chamber part 138 is L12. The third air chamber part 138 is formed such that a distance in the axis direction between the third protrusion end surface 128a and the third recess end surface 134a is H3.

In this way, the first protrusion enlarged diameter portion 126, the second protrusion enlarged diameter portion 127, and the third protrusion enlarged diameter portion 128 are fitted to the first recess enlarged diameter portion 132, the second recess enlarged diameter portion 133, and the third recess enlarged diameter portion 134. Thereby, the first air chamber part 136, the second air chamber part 137, and the third air chamber part 138 are intermittently formed in the axis direction as a plurality of air chambers between the outer circumferential surface 123a of the probe shaft portion 123 and the inner circumferential surface 124a of the shoulder.

By intermittently arranging the first air chamber part 136, the second air chamber part 137, and the third air chamber part 138 in the axis direction, even in a case where the relative position of the probe shaft part 123 and the shoulder 124 is displaced in the axis direction, it is possible to facilitate the control of volumes of the air chamber parts 136, 137, and 138. That is, the control width of the position accuracy of the probe shaft part 123 (friction stir welding tool 122) can be widened, and the function of the friction stir welding can be stably exerted.

Further, by adjusting the relative position of the friction stir welding tool 122 and the shoulder 124 with respect to the axis direction of the rotation axis 28, the distances H1, H2, and H3 of the first air chamber part 136, the second air chamber part 137, and the third air chamber part 138 can be adjusted. Thereby, it is possible to adjust the volumes of the first air chamber part 136, the second air chamber part 137, and the third air chamber part 138. Thereby, according to the friction stir welding apparatus 120, for example, the friction stir welding by the probe 26 can be applied to a wide variety of the first workpieces 21 and the second workpieces 22.

Further, a first communication part (communication chamber) 141 is formed of the first protrusion outer circumferential surface 126b and the first recess inner circumferential surface 132b. The first communication part 141 causes the first air chamber part 136 and the second air chamber part 137 to communicate with each other in the axis direction by a gap S. The first communication part 141 is formed such that a first communication part distance (distance) in the radial direction between the first protrusion outer circumferential surface 126b and the first recess inner circumferential surface 132b is L3. The communication part distance L3 is formed to be smaller (narrower) than the first air chamber distance L10 and the second air chamber distance L11.

Further, a second communication part (communication chamber) 142 is formed of the second protrusion outer circumferential surface 127b and the second recess inner circumferential surface 133b. The second communication part 142 causes the second air chamber part 137 and the third air chamber part 138 to communicate with each other in the axis direction by a gap S. The second communication part 142 is formed such that a second communication part distance (distance) in the radial direction between the second protrusion outer circumferential surface 127b and the second recess inner circumferential surface 133b is L3. The communication part distance L3 is formed to be smaller (narrower) than the second air chamber distance L11 and the third air chamber distance L12.

Further, a first pathway part 143 is formed of the outer circumferential surface 26a of the probe 26 and the inner circumferential surface 124a of the shoulder 124. The first pathway part 143 causes the step part 33 and the first air chamber part 136 to communicate with each other in the axis direction by a gap S. The first pathway part 143 is formed such that a first pathway part distance (distance) in the radial direction between the outer circumferential surface 26a of the probe 26 and the inner circumferential surface 124a of the shoulder 124 is L3 similarly to the first communication part distance and the second communication part distance. The first pathway part distance L3 is formed to be smaller (narrower) than the first air chamber distance L10.

Further, a second pathway part 144 is formed of the third protrusion outer circumferential surface 128b and the third recess inner circumferential surface 134b.

The second pathway part 144 causes the outside of the shoulder 124 and the third air chamber part 138 to communicate with each other in the axis direction by a gap S. The second pathway part 144 is formed such that a second pathway part distance in the radial direction between the third protrusion outer circumferential surface 128b and the third recess inner circumferential surface 134b is L3 similarly to the first communication part distance and the second communication part distance. The second pathway part distance L3 is formed to be smaller (narrower) than the third air chamber distance L12.

That is, the first air chamber part 136, the second air chamber part 137, and the third air chamber part 138 are formed to have a larger cross-sectional area compared to the first communication part 141, the second communication part 142, the first pathway part 143, and the second pathway part 144. The first air chamber part 136, the second air chamber part 137, and the third air chamber part 138 are formed to have a larger volume compared to the first communication part 141, the second communication part 142, the first pathway part 143, and the second pathway part 144.

A so-called labyrinth structure is formed of the first pathway part 143, the first air chamber part 136, the first communication part 141, the second air chamber part 137, the second communication part 142, the third air chamber part 138, and the second pathway part 144.

Next, an example in which a cutting chip (for example, a burr or the like) that is generated when the friction stir welding is performed by a friction stir welding method of the friction stir welding apparatus 120 of the fifth embodiment is prevented from entering the gap S between the probe 26 and the shoulder 124 is described with reference to FIG. 9 and FIG. 10.

According to the friction stir welding apparatus 120, the first air chamber part 136, the second air chamber part 137, and the third air chamber part 138 are formed between the outer circumferential surface 123a of the probe shaft part 123 and the inner circumferential surface 124a of the shoulder 124. Further, the first communication part 141 causes the first air chamber part 136 and the second air chamber part 137 to communicate with each other, and the second communication part 142 causes the second air chamber part 137 and the third air chamber part 138 to communicate with each other.

Accordingly, the cutting chip that is generated at the time of friction stir welding of the second workpiece 22 and the first workpiece 21 at the joint part 23 enters and is accumulated in the first air chamber part 136 via the first pathway part 143 from the step part 33 as indicated by an arrow J.

The first pathway part 143 is formed such that the first pathway part distance L3 is smaller than the first air chamber distance L10 of the first air chamber part 136. Accordingly, the cutting chip enters the first air chamber part 136 from the first pathway part 143, and thereby, the pressure of the cutting chip is lowered due to a pressure loss.

Further, the cutting chip that is accumulated in the first air chamber part 136 enters the first communication part 141 as indicated by an arrow K. The cutting chip that has entered the first communication part 141 enters and is accumulated in the second air chamber part 137 via the first communication part 141 as indicated by the arrow K.

The first communication part 141 is formed such that the communication part distance L3 is smaller than the second air chamber distance L11 of the second air chamber part 137. Accordingly, the cutting chip enters the second air chamber part 137 from the first communication part 141, and thereby, the pressure of the cutting chip is lowered due to a pressure loss.

Further, the cutting chip that is accumulated in the second air chamber part 137 enters the second communication part 142 from the second air chamber part 137 as indicated by an arrow L. The cutting chip that has entered the second communication part 142 enters and is accumulated in the third air chamber part 138 via the second communication part 142 as indicated by the arrow L.

The second communication part 142 is formed such that the second communication part distance L3 is smaller than the third air chamber distance L12 of the third air chamber part 138. Accordingly, the cutting chip enters the third air chamber part 138 from the second communication part 142, and thereby, the pressure of the cutting chip is lowered due to a pressure loss.

Additionally, the cutting chip that is accumulated in the third air chamber part 138 enters the second pathway part 144 from the third air chamber part 138 as indicated by an arrow M. The second pathway part 144 is formed such that the second pathway part distance L3 is smaller than the third air chamber distance L12 of the third air chamber part 138.

In this way, the cutting chip repeatedly enters the first air chamber part 136, the first communication part 141, the second air chamber part 137, the second communication part 142, the third air chamber part 138, and the second pathway part 144 in order. Accordingly, for example, even the cutting chip having enhanced fluidity due to frictional heat as in the first embodiment can generate a pressure loss, and it is possible to sufficiently prevent the flow of the cutting chip.

Further, the first protrusion end surface 126a, the second protrusion end surface 127a, and the third protrusion end surface 128a are surfaces that face the joint part 23. Accordingly, the cutting chip that has entered the first air chamber part 136, the second air chamber part 137, and the third air chamber part 138 hits the protrusion end surfaces 126a, 127a, and 128a, respectively, and the flow of the cutting chip is prevented by a resistance by the protrusion end surfaces 126a, 127a, and 128a.

Additionally, the labyrinth structure is formed of the first pathway part 143, the first air chamber part 136, the first communication part 141, the second air chamber part 137, the second communication part 142, the third air chamber part 138, and the second pathway part 144. Accordingly, it is possible to further sufficiently prevent the flow of the cutting chip even when the cutting chip has enhanced fluidity by frictional heat.

Thereby, it is possible to prevent the cutting chip that is generated at the time of friction stir welding of the second workpiece 22 and the first workpiece 21 at the joint part 23 from entering the gap S between the probe 26 and the shoulder 124. Accordingly, it is possible to improve the quality of the joint part 23 at which the second workpiece 22 and the first workpiece 21 are welded by the friction stir welding using the probe 26.

Further, according to the friction stir welding apparatus 120, the first pathway part 143 is formed of the end part 26b of the probe 26 and the end part 124b of the shoulder 124. Further, the first pathway part distance L3 that is formed of the outer circumferential surface 26a of the probe 26 and the inner circumferential surface 124a of the shoulder 124 is formed to be smaller (narrower) than the first air chamber distance L10 of the first air chamber part 136.

Accordingly, it is possible to prevent the cutting chip that is generated at the time of friction stir welding of the second workpiece 22 and the first workpiece 21 at the joint part 23 from entering the first air chamber part 136 that is located at a position closest to the joint part 23 by the gap S of the first pathway part 143 even when the fluidity is enhanced by the frictional heat. Thereby, it is possible to further favorably prevent the cutting chip that is generated at the time of friction stir welding of the second workpiece 22 and the first workpiece 21 at the joint part 23 from entering the gap S between the probe 26 and the shoulder 124. Accordingly, it is possible to further favorably improve the quality of the joint part 23 at which the second workpiece 22 and the first workpiece 21 are welded by the friction stir welding using the probe 26.

### Sixth Embodiment

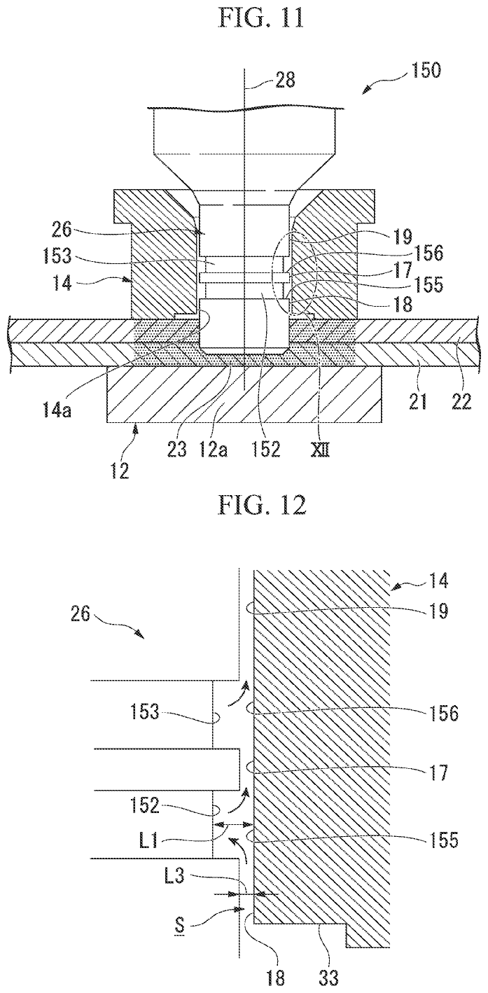

As shown in FIG. 11 and FIG. 12, a friction stir welding apparatus 150 is an apparatus in which a first groove part 152 and a second groove part 153 are formed on the outer circumferential surface 26a of the probe 26 in place of the first groove part 36 and the second groove part 37 of the first embodiment, and the other configurations are substantially similar to those of the first embodiment.

The friction stir welding apparatus 150 includes a first air chamber part 155, a second air chamber part 156, a communication part 17, a first pathway part 18, and a second pathway part 19 similarly to the first air chamber part 15, the second air chamber part 16, the communication part 17, the first pathway part 18, and the second pathway part 19 of the first embodiment.

According to the friction stir welding apparatus 150, since the first groove part 152 and the second groove part 153 can be formed on the outer circumferential surface 26a of the probe 26, an outer circumference processing can be used. Accordingly, the first groove part 152 and the second groove part 153 can be easily formed on the outer circumferential surface 26a of the probe 26 compared to a case in which the groove part is processed on the inner circumferential surface 14a of the shoulder 14 using an inner circumference processing.

Thereby, the first air chamber part 155 (a plurality of air chambers) and the second air chamber part 156 (a plurality of air chambers) can be easily formed between the outer circumferential surface 26a of the probe 26 and the inner circumferential surface 14a of the shoulder 14.

Further, the first air chamber part 155 and the second air chamber part 156 are arranged in the axis direction. Thereby, even in a case where the relative position of the probe 26 and the shoulder 14 is displaced in the axis direction, it is possible to facilitate the control of volumes of the first air chamber part 155 and the second air chamber part 156. That is, the control width of the position accuracy of the probe 26 can be widened, and the function of the friction stir welding can be stably exerted.

Next, an example in which a cutting chip (for example, a burr or the like) that is generated when the friction stir welding is performed by a friction stir welding method of the friction stir welding apparatus 150 of the sixth embodiment is prevented from entering the gap S between the probe 26 and the shoulder 14 is described with reference to FIG. 11 and FIG. 12.

According to the friction stir welding method of the friction stir welding apparatus 150, the cutting chip repeatedly enters the first air chamber part 155, the communication part 17, the second air chamber part 156, and the second pathway part 19 in order, as indicated by the arrow similarly to the friction stir welding method of the first embodiment. Accordingly, for example, it is possible to sufficiently prevent the flow of the cutting chip even when the cutting chip has enhanced fluidity by frictional heat.

Thereby, it is possible to prevent the cutting chip that is generated at the time of friction stir welding from entering the gap S between the probe 26 and the shoulder 14. Accordingly, it is possible to improve the quality of the joint part 23 at which the second workpiece 22 and the first workpiece 21 are welded by the friction stir welding using the probe 26.

Further, according to the friction stir welding apparatus 150, the first pathway part distance L3 of the first pathway part 18 is formed to be smaller (narrower) than the first air chamber distance L1 of the first air chamber part 155. Accordingly, it is possible to prevent the cutting chip that is generated at the time of friction stir welding at the joint part 23 from entering the first air chamber part 155 that is located at a position closest to the joint part 23 by the gap S of the first pathway part 18 even when the fluidity is enhanced by the frictional heat.

Thereby, it is possible to further favorably prevent the cutting chip that is generated at the time of friction stir welding at the joint part 23 from entering the gap S between the probe 26 and the shoulder 14.

### Seventh Embodiment

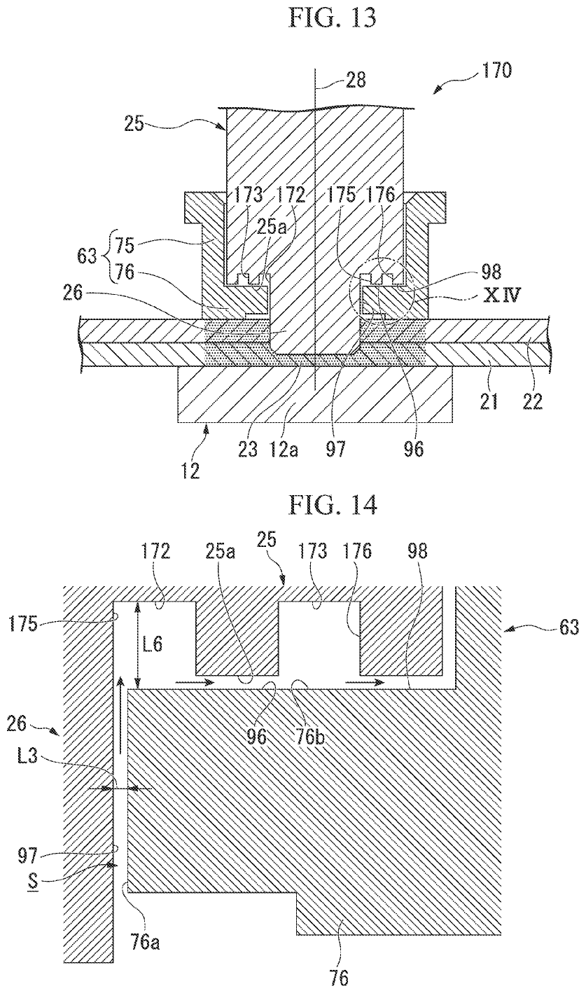

As shown in FIG. 13 and FIG. 14, a friction stir welding apparatus 170 is an apparatus in which instead of the groove part that is formed on the shoulder bottom part 76 using the protrusion part 81 and the step part 92 of the third embodiment, a first groove part 172 and a second groove part 173 are formed on an end surface (outer surface) 25a of the probe shaft part (probe) 25.

The friction stir welding apparatus 170 includes a first air chamber part 175, a second air chamber part 176, a communication part 96, a first pathway part 97, and a second pathway part 98 similarly to the first air chamber part 94, the second air chamber part 95, the communication part 96, the first pathway part 97, and the second pathway part 98 of the third embodiment.

According to the friction stir welding apparatus 170, since the first groove part 172 and the second groove part 173 can be formed on the end surface 25a of the probe shaft part 25, an outer surface processing can be used. Accordingly, the first groove part 172 and the second groove part 173 can be easily formed on the end surface 25a of the probe shaft part 25 compared to a case in which the groove part is processed on the inner surface (an inner surface of the shoulder) 76b of the shoulder bottom part 76 using an inner surface processing.

Thereby, the first air chamber part 175 (a plurality of air chambers) and the second air chamber part 176 (a plurality of air chambers) can be easily formed between the end surface 25a of the probe shaft part 25 and the inner surface 76b of the shoulder bottom part 76.

Next, an example in which a cutting chip (for example, a burr or the like) that is generated when the friction stir welding is performed by a friction stir welding method of the friction stir welding apparatus 170 of the seventh embodiment is prevented from entering the gap S between the probe 26 and the shoulder 63 is described with reference to FIG. 13 and FIG. 14.

According to the friction stir welding method of the friction stir welding apparatus 170, the cutting chip repeatedly enters the first air chamber part 175, the communication part 96, the second air chamber part 176, and the second pathway part 98 in order, as indicated by the arrow similarly to the friction stir welding method of the first embodiment. Accordingly, for example, it is possible to sufficiently prevent the flow of the cutting chip even when the cutting chip has enhanced fluidity by frictional heat.

Thereby, it is possible to prevent the cutting chip that is generated at the time of friction stir welding from entering the gap S between the probe 26 and the shoulder 63. Accordingly, it is possible to improve the quality of the joint part 23 at which the second workpiece 22 and the first workpiece 21 are welded by the friction stir welding using the probe 26.

Further, according to the friction stir welding apparatus 170, the first pathway part distance L3 of the first pathway part 97 is formed to be smaller (narrower) than the first air chamber distance L6 of the first air chamber part 175. The first air chamber part 175 is formed to be larger than the first pathway part distance L3 in a cross section perpendicular to the rotation axis 28, and when the cutting chip enters the first air chamber part 175 from the first pathway part 97, a pressure loss is generated. Accordingly, it is possible to prevent the cutting chip that is generated at the time of friction stir welding at the joint part 23 from entering the first air chamber part 175 that is located at a position closest to the joint part 23 by the gap S of the first pathway part 97 even when the fluidity is enhanced by the frictional heat.

Thereby, it is possible to further favorably prevent the cutting chip that is generated at the time of friction stir welding at the joint part 23 from entering the gap S between the probe 26 and the shoulder 63.

### Eighth Embodiment

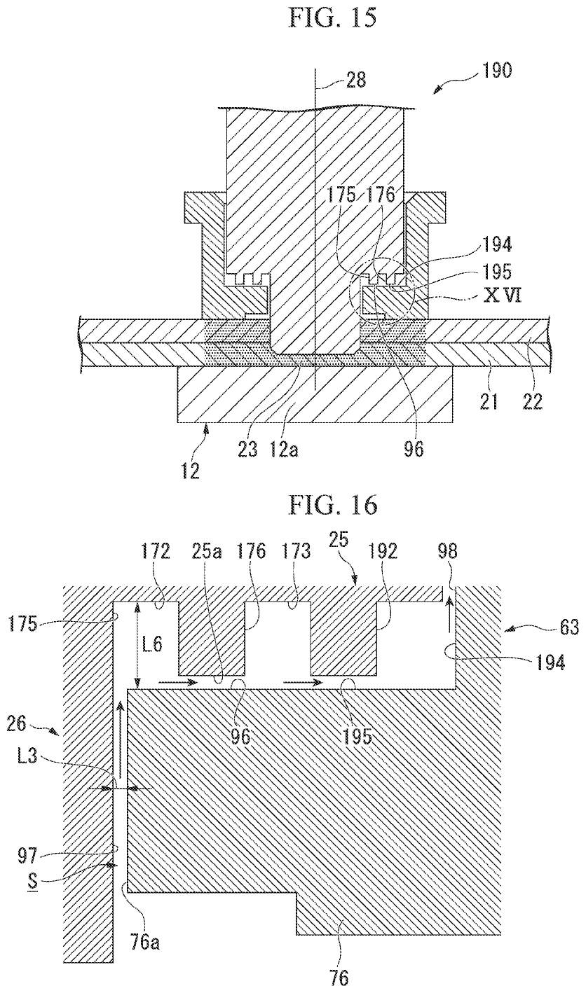

As shown in FIG. 15 and FIG. 16, a friction stir welding apparatus 190 is an apparatus in which a third groove part 192 is formed on an outer circumference part in the end surface 25a of the probe shaft part 25 of the seventh embodiment, and the other configurations are substantially similar to those of the seventh embodiment.

That is, the friction stir welding apparatus 190 includes a third air chamber part 194 and a communication part 195 in addition to the first air chamber part 175, the second air chamber part 176, the communication part 96, the first pathway part 97, and the second pathway part 98 of the seventh embodiment.

According to the friction stir welding apparatus 190, since the first groove part 172, the second groove part 173, and the third groove part 192 can be formed on the end surface 25a of the probe shaft part 25 similarly to the seventh embodiment, an outer surface processing can be used. Accordingly, the first groove part 172, the second groove part 173, and the third groove part 192 can be easily formed on the end surface 25a of the probe shaft part 25.

Thereby, the first air chamber part 175, the second air chamber part 176, and the third groove part 194 (a plurality of air chambers) can be easily formed between the end surface 25a of the probe shaft part 25 and the inner surface 76b of the shoulder bottom part 76.

Next, an example in which a cutting chip (for example, a burr or the like) that is generated when the friction stir welding is performed by a friction stir welding method of the friction stir welding apparatus 190 of the eighth embodiment is prevented from entering the gap S between the probe 26 and the shoulder 63 is described with reference to FIG. 15 and FIG. 16.

According to the friction stir welding method of the friction stir welding apparatus 190, the cutting chip repeatedly enters the first air chamber part 175, the communication part 96, the second air chamber part 176, the communication part 195, the third air chamber part 194, and the second pathway part 98 in order, as indicated by the arrow similarly to the friction stir welding method of the seventh embodiment. Accordingly, for example, it is possible to sufficiently prevent the flow of the cutting chip even when the cutting chip has enhanced fluidity by frictional heat.

Thereby, it is possible to prevent the cutting chip that is generated at the time of friction stir welding from entering the gap S between the probe 26 and the shoulder 63. Accordingly, it is possible to improve the quality of the joint part 23 at which the second workpiece 22 and the first workpiece 21 are welded by the friction stir welding using the probe 26.

Further, according to the friction stir welding apparatus 190, the first pathway part distance L3 of the first pathway part 97 is formed to be smaller (narrower) than the first air chamber distance L6 of the first air chamber part 175. The first air chamber part 175 is formed to be larger than the first pathway part distance L3 in a cross section perpendicular to the rotation axis 28, and when the cutting chip enters the first air chamber part 175 from the first pathway part 97, a pressure loss is generated. Accordingly, it is possible to prevent the cutting chip that is generated at the time of friction stir welding at the joint part 23 from entering the first air chamber part 175 that is located at a position closest to the joint part 23 by the gap S of the first pathway part 97 even when the fluidity is enhanced by the frictional heat.

Thereby, it is possible to further favorably prevent the cutting chip that is generated at the time of friction stir welding at the joint part 23 from entering the gap S between the probe 26 and the shoulder 63.

### Ninth Embodiment

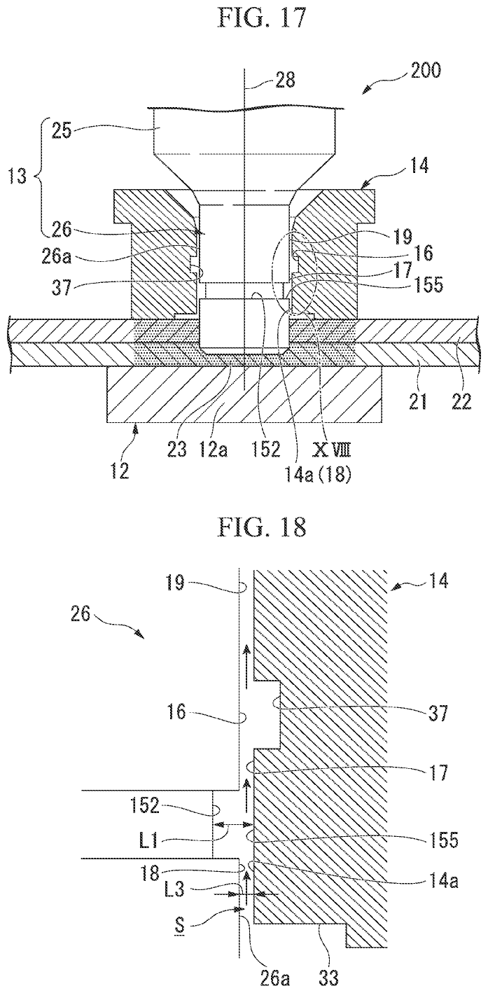

As shown in FIG. 17 and FIG. 18, a friction stir welding apparatus 200 is an apparatus in which the first groove part 152 of the sixth embodiment is formed on the outer circumferential surface 26a of the probe 26, and the second groove part 37 of the first embodiment is formed on the inner circumferential surface 14a of the shoulder 14.

In the friction stir welding apparatus 200, in the axis direction, the first pathway part 18, the first air chamber part 155, the communication part 17, the second air chamber part 16, and the second pathway part 19 are formed in this order from the side of the joint part 23 toward the opposite side of the joint part 23 substantially similarly to the first embodiment and the sixth embodiment.

According to the friction stir welding apparatus 200, two groove parts of the first groove part 152 and the second groove part 37 are separately formed on the outer circumferential surface 26a of the probe 26 and the inner circumferential surface 14a of the shoulder 14, respectively. Accordingly, it is possible to enhance the degree of freedom of the distance in the axis direction of the first groove part 152 and the second groove part 37, for example, compared to a case in which the two groove parts of the first groove part 152 and the second groove part 37 are formed integrally on one of the probe 26 and the shoulder 14. Further, it is possible to enhance the degree of freedom of the groove depth in the radial direction of the first groove part 152 and the second groove part 37.

Thereby, by forming the two groove parts of the first groove part 152 and the second groove part 37 separately on the probe 26 and the shoulder 14, it is possible to enhance the volume efficiency of the air chamber parts 155 and 37 in the axis direction and the radial direction, and it is possible to contribute to the reduction in size of the friction stir welding tool 13.

Next, an example in which a cutting chip (for example, a burr or the like) that is generated when the friction stir welding is performed by a friction stir welding method of the friction stir welding apparatus 200 of the ninth embodiment is prevented from entering the gap S between the probe 26 and the shoulder 14 is described with reference to FIG. 17 and FIG. 18.

According to the friction stir welding method of the friction stir welding apparatus 200, the cutting chip repeatedly enters the first air chamber part 155, the communication part 17, the second air chamber part 16, and the second pathway part 19 in order, as indicated by the arrow similarly to the friction stir welding method of the first embodiment. Accordingly, for example, it is possible to sufficiently prevent the flow of the cutting chip even when the cutting chip has enhanced fluidity by frictional heat.

Thereby, it is possible to prevent the cutting chip that is generated at the time of friction stir welding from entering the gap S between the probe 26 and the shoulder 14. Accordingly, it is possible to improve the quality of the joint part 23 at which the second workpiece 22 and the first workpiece 21 are welded by the friction stir welding using the probe 26.

Further, according to the friction stir welding apparatus 200, the first pathway part distance L3 of the first pathway part 18 is formed to be smaller (narrower) than the first air chamber distance L1 of the first air chamber part 155. Accordingly, it is possible to prevent the cutting chip that is generated at the time of friction stir welding at the joint part 23 from entering the first air chamber part 155 that is located at a position closest to the joint part 23 by the gap S of the first pathway part 18 even when the fluidity is enhanced by the frictional heat.

Thereby, it is possible to further favorably prevent the cutting chip that is generated at the time of friction stir welding at the joint part 23 from entering the gap S between the probe 26 and the shoulder 14.

The technical scope of the present invention is not limited to the embodiments described above, and various changes can be added without departing from the scope of the present invention. The configuration elements in the embodiments described above can be replaced by known configuration elements without departing from the scope of the present invention, and the modification examples described above may be suitably combined.

For example, the communication part distance L3, the first communication part distance L3, the second communication part distance L3, the first pathway part distance L3, and the second pathway part distance L3 may be an identical dimension, or at least one may be a dimension different from a dimension of the others.

What is claimed is:

1. A friction stir welding apparatus, comprising:
a probe that is pressed to a joint part of a plurality of laminated joined members while being rotated;
a shoulder that surrounds the probe at an outside in a radial direction with respect to a rotation axis of the probe;
a plurality of air chambers that are formed between an outer surface of the probe and an inner surface of the shoulder; and
a communication part that causes the plurality of air chambers to communicate with each other and is formed such that a distance between the probe and the shoulder is smaller than those of the plurality of air chambers.

2. The friction stir welding apparatus according to claim 1,
wherein the outer surface of the probe and the inner surface of the shoulder are intermittently radially enlarged in an axis direction of the rotation axis from a side of the joined member toward an opposite side, and
the plurality of air chambers are formed of a radially enlarged portion of the probe and a radially enlarged portion of the shoulder.

3. The friction stir welding apparatus according to claim 1,
wherein a distance between an end part of the probe and an end part of the shoulder is smaller than a distance between an outer surface of the probe and an inner surface of the shoulder in an air chamber that is located at a closest position to the joint part among the plurality of air chambers.

4. The friction stir welding apparatus according to claim 2,
wherein a distance between an end part of the probe and an end part of the shoulder is smaller than a distance between an outer surface of the probe and an inner surface of the shoulder in an air chamber that is located at a closest position to the joint part among the plurality of air chambers.

5. A friction stir welding method using the friction stir welding apparatus according to claim 1,
wherein rotation numbers of the probe and the shoulder are different from each other.

6. A friction stir welding method using the friction stir welding apparatus according to claim 2,
wherein rotation numbers of the probe and the shoulder are different from each other.

7. A friction stir welding method using the friction stir welding apparatus according to claim 3,
wherein rotation numbers of the probe and the shoulder are different from each other.

8. A friction stir welding method using the friction stir welding apparatus according to claim 4,
wherein rotation numbers of the probe and the shoulder are different from each other.
